(19) United States
(12) Patent Application Publication
(10) Pub. No.: US 2026/0139956 A1
(43) Pub. Date: May 21, 2026

(54) INFORMATION PROCESSING METHOD, COMPUTER, AND RECORDING MEDIUM

(71) Applicant: Panasonic Automotive Systems Co., Ltd., Kanagawa (JP)

(72) Inventor: Hiroshi YAHATA, Osaka Fu (JP)

(73) Assignee: Panasonic Automotive Systems Co., Ltd., Kanagawa (JP)

(21) Appl. No.: 19/365,976

(22) Filed: Oct. 22, 2025

(30) Foreign Application Priority Data
Nov. 20, 2024 (JP) 2024-202632

(51) Int. Cl. G01C 21/36; B60W 60/00; G05B 13/02; G10L 15/22; G10L 15/30; G10L 15/32

(52) U.S. Cl. CPC G01C 21/3608; B60W 60/001; G05B 13/0265; G10L 15/22; G10L 15/30; G10L 15/32; B60W 2540/21

(57) ABSTRACT

An information processing method is executed by a computer in a system incidental to a room. An Artificial Intelligence (AI) agent includes a room AI agent and personal AI agents. The room AI agent receives and responds to an instruction from a user in the room via a voice interaction interface (VUI). The personal AI agents correspond to users in the room. The information processing method includes connecting each AI agent to a virtual space enabling interaction with each other. The room AI agent recognizes the user in the room and a topic of a proposal request from the user via the VUI and notifies the topic and personal AI agents of the recognized user. The personal AI agents generate one or more proposals based on the topic and user's profile. The computer applies, to the system, a setting or processing corresponding to a proposal adopted by the user.

### CROSS-REFERENCE TO RELATED APPLICATIONS

This application is based upon and claims the benefit of priority from Japanese Patent Application No. 2024-202632, filed on Nov. 20, 2024, the entire contents of which are incorporated herein by reference.

### FIELD

Embodiments described herein relate generally to an information processing method, a computer, and a recording medium.

### BACKGROUND

A system for calling a voice interaction agent has been known (See, for example, JP 2021-117302 A).

In a conventional voice human-agent interaction system, further improvement has been required.

### SUMMARY

An information processing method according to one aspect of the present disclosure is an information processing method of an Artificial Intelligence (AI) agent executed by a computer. The computer is included in a system incidental to a room. The AI agent includes a room AI agent and one or more personal AI agents. The room AI agent serves to receive and respond to an instruction from a user in the room via a voice interaction interface (VUI). The one or more personal AI agents correspond to one or more users in the room. The information processing method includes connecting the one or more personal AI agents and the room AI agent to a virtual space where interaction between the one or more personal AI agents and the room AI agent is enabled. The information processing method includes, in a case where a proposal request regarding a topic is made by one or more users in the room, recognizing, by the room AI agent connected to the virtual space, the topic and the one or more users who have made the proposal request via the voice interaction interface (VUI) and notifying the one or more personal AI agents connected to the virtual space of a result of the recognition. The information processing method includes generating, by the one or more personal AI agents connected to the virtual space, one or more proposals based on the recognized topic and a profile of the recognized user. The information processing method includes, in a case where a proposal is adopted by the user from among the generated one or more proposals, causing the computer to apply, for a system incidental to the room, setting or processing corresponding to the adopted proposal.

### BRIEF DESCRIPTION OF THE DRAWINGS

FIG. 1 is a diagram illustrating an example of an overall configuration of a human-agent interaction system according to the present embodiment;

FIG. 2A is a diagram illustrating an example of a hardware configuration of the human-agent interaction system according to the present embodiment;

FIG. 2B is a flowchart illustrating an example of a procedure of processing of a human-agent interaction system according to the present embodiment;

FIG. 3 is a diagram for describing an example of connecting an agent to be used by a user to the human-agent interaction system according to the present embodiment;

FIG. 4 is a sequence diagram illustrating an example of a procedure of connecting an agent to be used by a user to the human-agent interaction system according to the present embodiment;

FIG. 5 is a diagram for describing an example of connecting an agent to be used by a user to the human-agent interaction system according to the present embodiment;

FIG. 6 is a diagram for describing an example of adding the human-agent interaction system according to the present embodiment to a conversation group in which an agent used by a user participates;

FIG. 7 is a sequence diagram illustrating an example of a procedure of adding the human-agent interaction system according to the present embodiment to a conversation group in which an agent used by a user participates and excluding the system from the conversation group;

FIG. 8 is a sequence diagram illustrating an example of a procedure of processing in which, in the human-agent interaction system according to the present embodiment, a vehicle agent narrows down candidates to be recommended to a user by using an agent of each user, causes the user to determine acceptance or rejection of the candidates, and reflects the determination in an in-vehicle system;

FIG. 9 is a diagram illustrating an example in which, in the human-agent interaction system according to the present embodiment, a vehicle agent narrows down candidates to be recommended to a user by using an agent of each user, causes the user to determine acceptance or rejection of the candidates, and reflects the determination in an in-vehicle system (navigation system);

FIG. 10 is a sequence diagram illustrating an example of a procedure of processing in which, in the human-agent interaction system according to the present embodiment, a vehicle agent narrows down candidates to be recommended to a user by using an agent of each user, causes the user to determine acceptance or rejection of the candidates, and reflects the determination in an in-vehicle system (navigation system);

FIG. 11 is a diagram for describing an example of an interaction history between agents regarding processing in which, in the human-agent interaction system according to the present embodiment (in a cyber-vehicle room), a vehicle agent narrows down candidates to be recommended to a user by using an agent of each user, causes the user to determine acceptance or rejection of the candidates, and reflects the determination in an in-vehicle system (navigation system);

FIG. 12 is a flowchart diagram illustrating an example of a procedure of processing in which, in the human-agent interaction system according to the present embodiment, a vehicle agent narrows down candidates to be recommended to a user by using an agent of each user, and causes the user to determine acceptance or rejection of the candidates;

FIG. 13 is a sequence diagram illustrating an example of a procedure of processing in which, in the human-agent interaction system according to the present embodiment, a vehicle agent narrows down candidates to be recommended to a user by using an agent of each user, causes the user to determine acceptance or rejection of the candidates, and reflects the determination in an in-vehicle system (navigation system);

FIG. 14 is a flowchart illustrating an example of a procedure of processing of switching transmission destinations according to a property of information when an agent transmits information in the human-agent interaction system according to the present embodiment;

FIG. 15 is a diagram illustrating an example in which a vehicle agent responds to an inquiry about privacy of a user by individually communicating only with an agent of the user in the human-agent interaction system according to the present embodiment;

FIG. 16 is a sequence diagram illustrating an example of a procedure in which a vehicle agent responds to an inquiry regarding privacy of a user by individually communicating only with an agent of the user in the human-agent interaction system according to the present embodiment;

FIG. 17 is a diagram illustrating an example in which a vehicle agent uses an API (HTTP request/response) when individually communicating with an agent of a user in the human-agent interaction system according to the present embodiment;

FIG. 18 is a diagram illustrating an example of user data referred to by an agent of a user in the human-agent interaction system according to the present embodiment; and

FIG. 19 is a diagram illustrating an example of cooperation between a software configuration and a hardware configuration of the human-agent interaction system according to the present embodiment.

### DETAILED DESCRIPTION

### Knowledge Underlying the Present Disclosure

In recent years, technology development of an Artificial Intelligence (AI) agent using a large-scale language model (LLM) has progressed.

The AI agent has short/long term memory (user attribute, use log, or a part thereof) in a form that can be directly or indirectly referred to, and can autonomously communicate with an external application or a web service via a network, and start or operate another application or web service. As a result, the AI agent is a computer system that sets or updates a goal via communication with the user by text or voice (instruction content to the AI is also referred to as a prompt), autonomously generates a task group necessary for achieving the goal, and executes information processing of the generated task sequentially autonomously or while communicating with the user, thereby achieving the final goal, or a software program that executes the computer system.

AI that can handle information, not only one modal (data format) such as text, for example, but also combination of a plurality of different modalities such as voice and image and can perform input or output information processing is referred to as multi-modal AI, and technology development of a multi-modal AI agent is also in progress.

The AI agent can be added with expertise and characteristics based on a database referred to when performing information processing and an algorithm for task generation. As a result, the AI agent can be implemented as, for example, a highly specialized agent specialized in a specific function. On the other hand, the AI agent can be implemented as a personalized AI agent close to an individual user by training preference, biometric information, and past behavior history of the user who communicates with the AI agent, accessing a database in which data of such an individual user is accumulated (hereinafter, referred to as user attribute information), or analyzing the data (hereinafter, referred to as profiling). The former AI agent may be referred to as a specialized agent, and the latter AI agent may be referred to as a partner-type agent.

It is contemplated that a partner-type agent may function as a particularly effective partner in a mobility space. This is because when the user moves to a place different from the normal range of behavior by a vehicle and experiences a new (or unusual) experience, the partner-type agent can be a suitable navigator that closely follows the personality of the user. For example, the partner-type agent may make a selection or suggestion reflecting the user's preference when navigating the travel route of the vehicle. Examples of the user's preference include whether the user prefers the shortest route, prefers a road that is easy to drive due to sidewalk separation or the like, and prefers to stop at a tourist spot.

Similarly, the partner-type agent can suggest a candidate for sightseeing or a meal at the travel destination by reflecting the preference of the user and the past behavior history. For example, if the user likes a historic site, it is conceivable to propose a stopover to a historic site around the route, and if the user likes a local meal experience, it is conceivable to propose a meal in a restaurant where a famous dish in the area can be eaten.

The present inventor has studied a series of user experiences regarding use of a vehicle and use of an AI agent.

What is initially assumed is a setting method for connecting or disconnecting a vehicle agent available in a vehicle and an agent of a user who gets on the vehicle. A method of easily connecting the agent of the user to the vehicle agent when the user gets on the vehicle and a method of easily disconnecting the agent of the user from the vehicle agent when the user gets out of the vehicle have not been studied, and it seems that there is a new problem from the viewpoint of the user experience (hereinafter, abbreviated as UX) and the implementation means.

Moreover, the present inventor has considered that by connecting a vehicle agent and an agent of each user who gets on the vehicle, it is possible to support selection of one determination matter that satisfies all users from among a huge number of options regarding a travel route of the vehicle, a destination, and the like in consideration of a traffic jam situation that changes from moment to moment, a congestion status of a sightseeing spot or a restaurant, and further, preference and interest of each user who gets on the vehicle. However, even in this matter, there is no solution for supporting decision making or consensus building of one or more users in the vehicle interior, and it seems that the UX and the implementation means have unsolved problems.

In addition, in a case where the vehicle agent and the agent of each user are connected and exchange is shared in a place such as one online meeting room, it is considered that a new problem that the preference or interest of each user is shared by the agents of other users occurs. That is, there may be a new problem of information leakage to an agent used by another user.

In addition, as a case in which one or more users make a decision about moving or change their behavior, not only in a vehicle, but also a case in which a family talks about a topic such as travel in one room in a house before using the vehicle, a case in which a user talks with a colleague about a topic of potential new customers in a conference room in an office, and the like are assumed. For this reason, the passenger compartment, one room in the house, and a conference room in the workplace were considered as rooms in a broad sense, and consideration and knowledge were accumulated. As a common problem, it seems that it takes more time to form an agreement as the number of users is larger, and it is necessary to support the user to change the behavior of moving regarding the topic on which the agreement is formed.

Each aspect of the present disclosure described below is based on the above findings. However, the invention described in the claims is not limited by the above findings.

### Outline of Embodiment

An information processing method according to one of embodiments is an information processing method of an AI agent executed by a computer. The computer is included in a system incidental to a room. The AI agent includes a room AI agent and one or more personal AI agents. The room AI agent serves to receive and respond to an instruction from a user in the room via a voice interaction interface (VUI). The one or more personal AI agents correspond to one or more users in the room. The information processing method includes connecting the one or more personal AI agents and the room AI agent to a virtual space where interaction between the one or more personal AI agents and the room AI agent is enabled. The information processing method includes, in a case where a proposal request regarding a topic is made by one or more users in the room, recognizing, by the room AI agent connected to the virtual space, the topic and the one or more users who have made the proposal request via the voice interaction interface (VUI) and notifying the one or more personal AI agents connected to the virtual space of a result of the recognition. The information processing method includes generating, by the one or more personal AI agents connected to the virtual space, one or more proposals based on the recognized topic and a profile of the recognized user. The information processing method includes, in a case where a proposal is adopted by the user from among the generated one or more proposals, causing the computer to apply, for a system incidental to the room, setting or processing corresponding to the adopted proposal.

According to the configuration above, when there are plural users in the vehicle interior, the vehicle AI agent can generate a proposal that satisfies the request of the users in the vehicle interior while consulting with the AI agent of each user. For example, in a case where the AI agent of each user grasps and analyzes the individuality and preference of the user in the AI agent's charge (hereinafter, referred to as a profile), it is possible to notify the vehicle AI agent of a proposal candidate reflecting the individuality and preference of the users in the vehicle interior via the virtual space on behalf of the users in the vehicle interior. By adjusting the proposal candidate by the vehicle AI agent, it is possible to make a proposal that satisfies the needs of the users in the vehicle interior.

Unnecessary interaction between the users and the interaction system can be dispensed. This is because not the users in the vehicle interior but the AI agents which are alternatives of the users correspond during a period from when the vehicle AI agent receives the request from the users until it responds to the users. As a result, the load of the voice recognition processing can be reduced as compared with a case where the voice interaction is performed one by one between the vehicle AI agent and the user to adjust the opinion. Moreover, for example, in a case where there is a user who is performing a driving operation among the users, it is possible to reduce the cognitive load and reduce the risk of an accident or the like by dispensing with unnecessary interaction.

For example, if the vehicle is an autonomous vehicle such as a robot taxi (or a robotaxi), autonomous driving can be accomplished toward a destination or through a travel route, or in a manner of a driving operation, which all meet the needs of multiple users in the vehicle interior. Note that, in the present disclosure, the “destination” is understood to include not only the final destination but also a waypoint, and further include a parking position and a stop position.

The above-described “system incidental to a room” refers to a system configured to be able to control a predetermined service provided to a user who enters a room and exits from the room with respect to a predetermined space where the user enters and exits from the room, and includes at least one computer. The “predetermined service” may include a service related to space provision such as use reservation and access management, a service related to indoor environment such as indoor seats, lighting, and an air conditioner, a service for projecting materials, a map, and content, a service for providing communication with a remote place in a web conference, and the like. These services may be provided via the AI agent. In addition, the “predetermined space where the user enters and exits from” may be a mobility space provided for mobility such as a vehicle interior space (vehicle interior) of the vehicle, or an indoor space such as a conference room, a break room, or a private room (booth) for an online meeting. As an example, the “system incidental to a room” may be an in-vehicle system of a vehicle having a vehicle interior. In a case where the “system incidental” is an in-vehicle system, the “predetermined service” may include a driving assistance service such as navigation to a destination and the autonomous driving. Note that the “computer included in the system incidental to the room” may be, for example, only a first computer included in the in-vehicle system. In this case, the vehicle AI agent is implemented in the in-vehicle system. Alternatively, the “computer included in the system incidental to the room” may be multiple computers including the first computer included in the in-vehicle system and a second computer that cooperates with the first computer via a network. In this case, the vehicle AI agent may be implemented in the in-vehicle system or the second computer (for example, a server), or may be implemented in a distributed manner in both.

The above-described “virtual space” may be a virtual space managed by the first computer and/or the second computer. Alternatively, the “virtual space” may be a virtual space managed by a third computer (for example, a server) on a wide area network (for example, the Internet) operated by a business operator different from those of the first computer and/or the second computer. In a case where the virtual space is managed by the second computer or the third computer, the connection to the virtual space by the vehicle AI agent may be a connection using communication via the wide area network. In a case where the virtual space is managed by the first computer, the connection to the virtual space by the vehicle AI agent may be a connection in the in-vehicle system, and the connection to the virtual space by the first AI agent and the second AI agent may be, for example, a connection using P2P communication between an information terminal of each user and the in-vehicle system.

### Embodiment

Hereinafter, an example of an information processing method, a computer, a program, a communication terminal, and a human-agent interaction system according to the present embodiment will be described with reference to the drawings.

First, the definition of the artificial intelligence agent (AI agent) will be described. The AI agent is software or a computer system for achieving a predefined goal. The AI agent is designed to autonomously generate and select a behavior for achieving the goal based on external information acquired via a network regarding communication with the user, a situation of a surrounding space of the user, interaction with the user, and the like, and execute the behavior so as to achieve the goal. The communication with the user includes all means that convey user's emotions, intentions, and thoughts. For example, the communication with the user includes one or more means of a conversation, a pause before utterance, a tone of voice, an intention expression (GUI) via visual information such as letters and symbols, an intention expression means via a physical operation such as a button or a switch, and an intention expression means by a body motion such as an expression, a line of sight, a posture, or a gesture. In the present embodiment, the AI agent is also simply referred to as an agent. The agent may be expressed as a unique character (avatar) as a visual or auditory body expression when having a conversation or interaction with the user, and in that case, the agent has attribute information about the avatar. The attribute information about the avatar representing the character of the agent includes, for example, information regarding one or more of appearance, body, clothes, decorations, gesture, expression, voice, personality, taste, habit, knowledge, and experience of the avatar (record regarding the exchange with the user in the past).

That is, the “AI agent” according to the present disclosure is a computer system that autonomously completes processing intended or instructed by a user through API communication with the computer system or an operation of an application on behalf of the user in accordance with the intention or instruction or past behavior data of the user who is a human. That is, “the AI agent is connected to the virtual space” or “the AI agent performs the interactive processing in the virtual space” corresponds to the AI agent's participation in the online space such as the online meeting room or the chat room on behalf of the user. The “AI agent” interacts with another person or another AI agent and exchanges information using a mechanism capable of sharing information in the online space. For example, transmitting information to an unspecified number of people through a Social Networking Service (SNS) is also included in “connected to the virtual space”.

Specifically, by repeating “inputting” the output of “a certain AI agent” to “another AI agent” and then performing the opposite, a state in which two AI agents are virtually interacting can be created. In the human-agent interaction system according to the present disclosure, each of two or more AI agents interacts with another AI agent after understanding the corresponding user. The action of “inputting” the output of “a certain AI agent” to “another AI agent” may be implemented by the AI agent operating the browser by voice/GUI (automatically by software processing), may be implemented by using a chat room of an online meeting room, or may be implemented by performing information communication by API.

Therefore, the “AI agent” according to the present disclosure is a computer system capable of autonomously receiving a highly abstract task desired by a user and autonomously performing information processing necessary for accomplishing a series of tasks such as subdivision, processing, evaluation, and prioritization of next actions toward the accomplishment of the task.

In the following description, the agent used by the user will be described as including a program or a computer system designed and set so as to be able to autonomously communicate with a vehicle agent, an agent of another user, a Web service, or the like on behalf of the user on the basis of the preference of the user and the past behavior history.

### Configuration of Human-Agent Interaction System

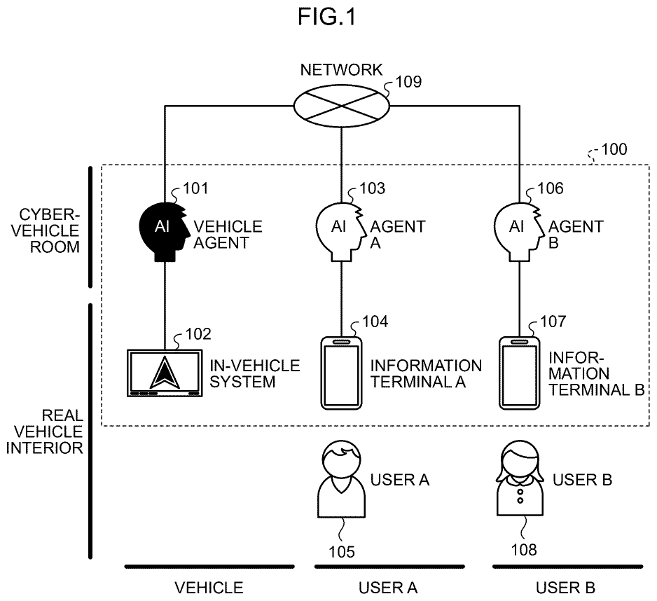

FIG. 1 is a diagram illustrating an example of an overall configuration of a human-agent interaction system 100 according to the present embodiment. Note that, in the present disclosure, for convenience of explanation, communication using text data, image data, voice data, tactile data, biometric information about a user, information obtained by combining one or more of them, or information obtained by processing one or more of them, other than interaction, may be collectively expressed as an interaction. This communication includes any communication among users, between users and agents, and between agents.

The human-agent interaction system 100 according to the embodiment is an example of a human-agent interaction system capable of interacting (capable of communicating) with the user.

As illustrated in FIG. 1, the human-agent interaction system 100 according to the present embodiment includes an in-vehicle system 102 installed in a vehicle, a vehicle agent 101 that is an agent that operates on the in-vehicle system 102 (or operates on a computer on a network that operates in cooperation with the in-vehicle system 102), an information terminal A 104 used by a user A who gets on the vehicle, an agent A 103 that is an agent that operates on the information terminal A 104 (or operates on a computer on a network that operates in conjunction with the information terminal A 104), an information terminal B 107 used by a user B 108 who gets on the vehicle, an agent B 106 that is an agent that operates on the information terminal B 107 (or operates on a computer on a network that operates in conjunction with the information terminal B 107), and a computer network that enables communication between the in-vehicle system 102, the information terminal A 104, and the information terminal B 107. The human-agent interaction system 100 is a system that not only includes these devices and agents as components, but also can exchange information between at least two or more agents connected via the network 109.

The vehicle agent 101 is an example of the room AI agent in this embodiment.

It is assumed that there is an agent that knows the user well (can access data including profile or user privacy information) for each user.

The agent that knows the user well for each user is an example of the personal AI agent in the present embodiment.

In a vehicle interior space (real vehicle interior) of the vehicle, there are the in-vehicle system 102, the user A, the information terminal A 104, the user B 108, and the information terminal B 107. On the other hand, an online virtual space (for example, an online meeting room) in which the vehicle agent 101 and the agent of the user who gets on the vehicle communicate with each other is referred to as a cyber-vehicle room. Although details will be described later, if the user gets on (enters) the real vehicle interior, it may be considered that an agent used by the user (or acting as a proxy) virtually gets on (enters) the cyber-vehicle room. Similarly, when the user gets off (exits from) the real vehicle interior, the agent of the user is also regarded as getting off (exits from) the cyber-vehicle room (for example, exit from the online meeting room), and the connection with other agents is disconnected.

The vehicle agent 101, which is a room AI agent, acquires, controls, or changes various types of information regarding the vehicle in cooperation with the in-vehicle system 102. For example, it is possible to acquire, control, or change the current position of the vehicle, driving-related information (such as information on moving speed and driving operation), sensor data (such as camera video) of the vehicle, remaining amount of gasoline, remaining battery level, setting of air conditioning and lighting in the vehicle interior, a route being set, content information being reproduced, and the like.

The agent A 103, which is a personal AI agent, cooperates with the information terminal A 104 to acquire, change, and record various types of information regarding the user (hereinafter, referred to as user data). For example, it is possible to acquire, change, or record a name of the user, a user name on the use of the service, an address, a gender, an age, a face image, a health condition, preference, knowledge, a behavior history, payment information such as a credit card or electronic money, biological information with real time, and the like. This user data may be securely recorded in the memory of the information terminal A 104, or may be recorded in the memory of an external computer connected via a network accessible when the agent A 103 needs the data. Similarly, the agent B 106 cooperates with the information terminal B 107.

By connecting the in-vehicle system 102, the information terminal A 104, and the information terminal B 107 via the network in this manner, agents corresponding to users in the real vehicle interior can be virtually connected and interact in the cyber-vehicle room on the network.

Note that, in the description of the present embodiment, when the user requests/responds to the in-vehicle system 102 or the vehicle agent 101, there is a case where it is not clearly distinguished to which the request/response is made. This is because which one is spoken to is the intention of the user at that time, and it is difficult to identify from an outsider. However, the in-vehicle system 102 in the real vehicle interior is a physical communication interface for a request/response of the user or the like, and the avatar of the vehicle agent 101 behaves as an interpersonal communication interface with the user via a UI unit 215 (described later) depending on the content of communication. In a case where it is emphasized that more interpersonal communication is performed, it is described that communication is performed with the vehicle agent 101 instead of the in-vehicle system 102.

Note that, here, a mode in which the agent of the user who gets on the real vehicle interior gets on (connects to) the cyber-vehicle room has been described, but the present disclosure is not limited thereto, and the agent that gets on (connects to) the cyber-vehicle room may be an agent of a user who does not get on the real vehicle interior. For example, by allowing an agent of the user who is at a remote location for some reason to get on the cyber-vehicle room, it is possible to share the voice in the real vehicle interior and the camera video provided in the vehicle with the computer used by the user at the remote location, thereby providing the simulated experience as if the user moves in the vehicle together.

Moreover, such a voice in the real vehicle interior, a current position of the vehicle, and a camera video may be shared with an in-vehicle system (or the vehicle agent 101) of another vehicle or an agent of a user in another vehicle. In this case, it is possible to smoothly perform communication beyond the vehicles in a case of moving together in multiple vehicles.

As described above, the vehicle interior space of the vehicle is reproduced in the cyberspace, and the vehicle agent 101 representing the vehicle and the agent representing the user are connected to the vehicle interior space as the basic structure. Therefore, it is possible to collect and analyze real-time information inside and outside the vehicle necessary in the cyber-vehicle room as needed, create a recommendation plan for the user in the real vehicle interior, and support the decision making of the user. Conventionally, there have been problems that information regarding the vicinity of the route is insufficient and more than one people cannot smoothly make one decision, but with the above-described configuration, it is possible to make the moving experience of the users in the real vehicle interior richer, more efficient, and more valuable.

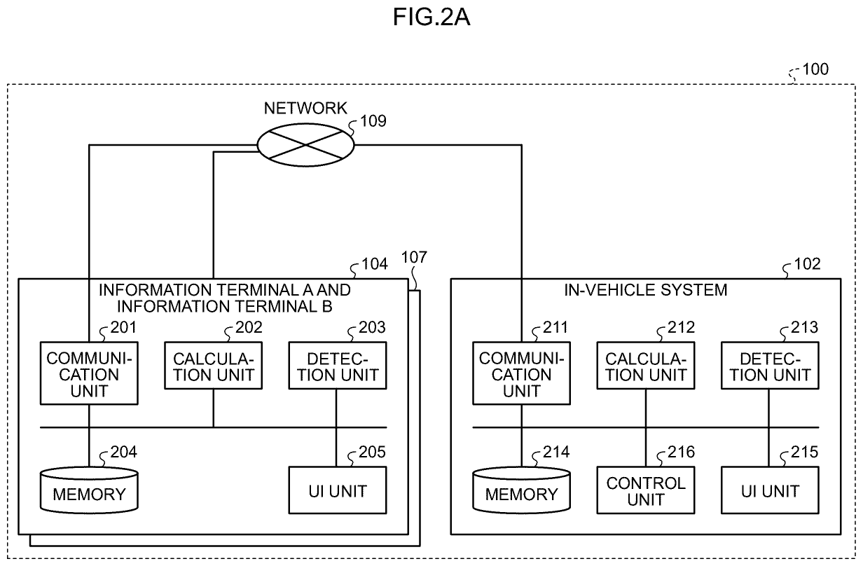

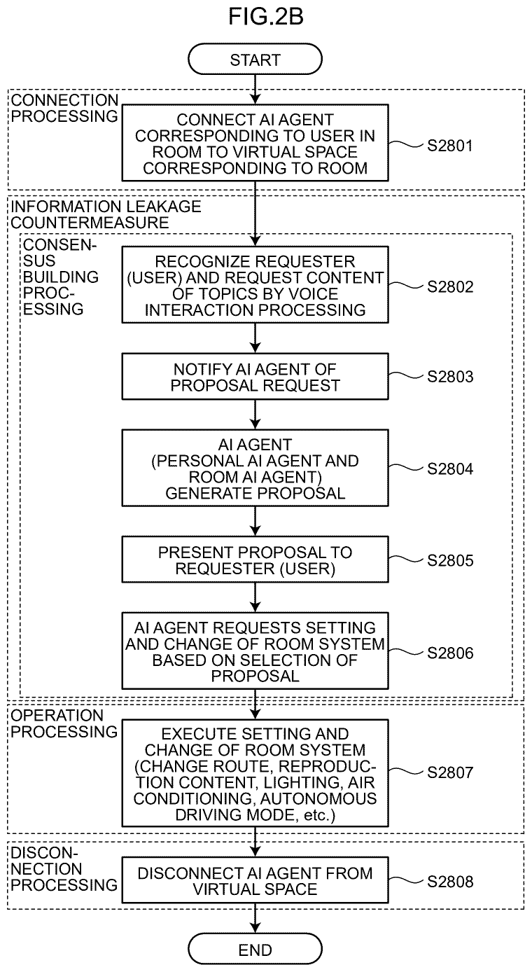

FIG. 2A is a diagram illustrating an example of a hardware configuration of the human-agent interaction system 100 according to the embodiment.

Both the information terminal A 104 and the information terminal B 107 have similar hardware configurations. A detection unit 203 for acquiring video information, audio information, and/or a physical quantity of a surrounding environment, a UI unit 205 that provides information based on video, audio, and vibration to a user and receives button pressing, a touch operation, and the like, a calculation unit 202 that performs various calculations including training/inference processing of an AI model performed in an information terminal and information processing such as image display and audio reproduction, a memory 204 that holds data and files used by the calculation unit, and a communication unit 201 for communicating with another computer on a communication network are included.

The UI unit 205 includes a display that displays a graphical user interface (GUI) and a speaker and a microphone that input and output a voice user interface (VUI). The calculation unit 202 is an example of an AI processor for causing an agent to execute generation processing. The memory 204 is an example of a memory that stores access information including an address (end point) for accessing the agent and agent attribute information regarding the agent. In addition, the memory 204 is an example of a memory that stores a use log of the agent by the user. In addition, the memory 204 is an example of a memory that stores use logs related to one or more agents available to the user.

In the present embodiment, the information terminal A 104 or the information terminal B 107 is described as a smartphone, but the present embodiment is not limited thereto. The present embodiment may be in the form of a wristwatch-type smartwatch, glasses-type smart glasses, a smart earphone worn on an ear, a ring-type smart ring, a smart speaker that performs voice operation, or a robot including a movable unit, and the form is not limited as long as the device can be worn or carried by a user.

The in-vehicle system 102 includes a communication unit 211 for communicating with other computers on a communication network, a memory 214 in which information regarding a vehicle and a management program thereof are recorded, and a calculation unit 212 that executes various data processing regarding a vehicle core system and a vehicle function including reproduction of a car navigation system and content, training and inference processing of a vehicle agent 101, and the like.

The in-vehicle system 102 includes a control unit 216 that controls and drives driving assistance and autonomous driving of the vehicle and a device in the real vehicle interior (seat, lighting, air conditioner, etc.), a detection unit 213 that detects a space and an object around the vehicle and a position and a state of a person and an object in the real vehicle interior, and a UI unit 215 that provides video and audio information and receives an input of a touch operation, an audio operation, or the like from a passenger. The driving assistance of the vehicle may be driving assistance in conjunction with a navigation system set as a destination, automatic detection when a route is deviated, an alarm, recalculation, predictive download of a map from a cloud, or the like.

The UI unit 215 includes a display that displays the GUI, and a speaker and a microphone that input and output the VUI. In addition, the detection unit 213 includes at least one of a camera or LiDAR for detecting a space or an object around the vehicle, an indoor camera or a vehicle interior monitoring system for imaging the real vehicle interior, a GPS sensor for measuring a current position of the vehicle, a sensor provided at each seat in the vehicle interior, and a sensor for detecting a traveling state or a control state of the vehicle or a driving operation by the driver. The calculation unit 212 is an example of an AI processor for causing a vehicle agent to execute generation processing. The memory 214 is an example of a memory that stores access information including an address for accessing the vehicle agent and agent attribute information regarding the vehicle agent. In the memory 214, for example, information for identifying a user who has used the vehicle in the past or an agent of the user may be recorded.

Note that the information terminal A 104, the information terminal B 107, and the in-vehicle system 102 may communicate by a communication means other than a computer network such as the Internet of a wide area communication network. For example, the near field communication may be used for the communication processing performed between the in-vehicle system 102 and the information terminal A 104.

FIG. 2B is a flowchart illustrating an example of an outline of information processing in the human-agent interaction system 100 according to the present embodiment.

The information processing in the human-agent interaction system 100 includes at least connection processing (S2801), consensus building processing (S2802 to S2806), operation processing (S2807), and disconnection processing (S2808).

In the connection processing, the AI agent is connected to the virtual space (S2801). The AI agent to be connected includes one or more personal AI agents corresponding to one or more users in the room respectively and a room AI agent corresponding to the room.

The personal AI agent is an agent that is close to the user, and can access and analyze (profile) data such as personal information, past behavior, and preference of the corresponding user. The personal AI agent is typically used by the user in an information terminal such as a smartphone owned by the user.

The room AI agent is an agent corresponding to a room that the user enters and exits from, and can set and change in the hardware incidental to or working in conjunction with the room and software for controlling the hardware. Hardware and software for controlling the hardware have a user interface, and the user interface includes the GUI provided via a display or the like, the VUI provided via a microphone, a speaker, or the like. Also included are a projector for projecting content, indoor lighting, and air conditioning. If the room is a vehicle interior, hardware that causes the vehicle interior to travel as a vehicle and software that controls the hardware, and hardware for travel support such as route guidance, navigation, and autonomous driving and software that controls the hardware are included. The autonomous driving is not limited to the fully autonomous driving, and includes limited autonomous driving such as a cruising mode in which the autonomous driving is released by a brake.

The virtual space corresponds to a room in which the user enters and exits from, and one or more connected personal AI agents and room AI agents perform cooperative processing. The cooperative processing includes processing aiming at Goal (proposal or the like) in an autonomous manner using the technology of the generative AI for the requested topic.

After the connection processing, consensus building processing is performed. The consensus building processing is processing aiming at Goal (proposal or the like) in an autonomous manner using the technology of the generative AI.

In the consensus building processing, if there is a request for a topic from a user in the room, the room AI agent corresponding to the room performs recognition of the requester (user) of the topic and grasping (recognition) of the request content by voice interaction processing (S2802).

The recognition of the user is typically performed by analyzing his/her utterance, but the requester of the topic may be analyzed by analyzing a video acquired by a camera in the room.

The room AI agent notifies the personal AI agent connected to the virtual space of the recognition result in the voice interaction processing, namely, the recognized requester (user) and the recognized (grasped) topic (S2803). For example, in a case where the users who have entered the room are two users A and B, and the user A requests a proposal for a shop with delicious ramen as a topic, the room AI agent notifies the personal AI agents of the user A and a user B connected to the virtual space that the proposal request for a delicious ramen shop has been requested as a topic from the user A.

The personal AI agent notified of the proposal related to the topic also uses the profile of the corresponding user to generate one or more proposals (S2804). The generated proposal may be accompanied by evaluation or recommended information. The room AI agent may determine effectiveness of the generated proposals and prioritize the generated proposals. The room AI agent grasps local information and map information about the area to which the destination belongs, such as the position of the room on the map and the information about the current time, and performs effectiveness determination and prioritization on the basis of these pieces of information.

For example, in a case where the user A does not like “hot” in the profile of the user A and the user B likes “hot” in the profile of user B, the store A (destination) that provides both “hot” and “mild” ramen and the store B (destination) that provides only “mild” ramen are proposed, and the proposal is accompanied by information indicating the degree of recommendation of 4 out of 5 for the store A, and the degree of recommendation of 3 for the store B. The reason why the store A is highly evaluated is to satisfy the preferences of both users.

The room AI agent may determine that the proposal of the store B is not effective and exclude it from the proposal if it is not possible to arrive at the store B during the lunch time or there is no parking lot in its neighborhood considering the distance from the room to the store A and the store B and the arrival time. In addition, the store C recognized may be separately added to the proposal. The recognition of the store C is acquired from, for example, an email for information on lunch time recommended restaurants which is electronically dropped into a district where the room is located.

Note that the local information and the map information about the area may be accessed by the personal AI agent instead of the room AI agent. However, there is a case where charging to a third party is required every time the local information and the map information are accessed. Therefore, it is more realistic that the room AI agent holding and accumulating information mainly the position where the room exists accesses to the local information and the map information than the personal AI agent corresponding to the user moving to each place accesses to the local information and the map information.

Once the AI agent generates a proposal, the proposal is presented to at least the requester (S2805). The presentation may be performed via the VUI of the voice interaction processing or may be performed via the GUI via a display or the like.

In a case where the user selects the presented proposal, the room AI agent requests a computer that is incidental to or works in conjunction with the room to set and change the room system (S2806).

The consensus building processing ends, and then operation processing is performed.

In the operation processing, the computer incidental to or working in conjunction with the room executes the requested setting and change of the room by hardware and software for controlling the hardware (S2807). Examples thereof include indoor lighting, air conditioning, and a content reproduction projector. If the room is a vehicle interior, examples include route guidance for moving to a destination, navigation, autonomous driving travel, and the like. In a case where the proposal of the delicious ramen shop A, which is an example of the topic, has been adopted by the user, content introducing the ramen shop A and access information are provided to the user using a projector or a display. In the case of the vehicle interior, route guidance, navigation, and autonomous driving with the ramen shop A set as a destination are performed. In a case where the control in conjunction with content to be reproduced is executed or moving is executed by the vehicle, lighting and air conditioning are controlled in response to an environmental change due to movement.

The disconnection processing is typically performed subsequent to the operation processing, but may be performed at any time after the connection processing. For example, it can be performed like a forced shutdown during the consensus building processing or the operation processing.

In the disconnection processing, the connection of the AI agent to the virtual space is disconnected (S2808). Among the AI agents, at least the personal AI agent is disconnected, but the room AI agent may be resident without being disconnected.

The disconnection is typically performed when an end instruction is received from a user in the room, but may be automatically performed when the user leaves the room. In the case of a conference room, it may be performed at the timing when the use of the conference room is completed. In the case of a vehicle, it may be performed at the timing when the vehicle arrives at the destination or at the timing when the vehicle is parked in a parking lot at home. If the vehicle is a rental car, it may be performed at the expiration of the contract period of the rental car or at the timing when the rental car is returned to the rental car shop. In a case where there are more than one users, only the personal AI agent of a user who has left the room may be disconnected.

Hereinafter, details of the embodiment outlined in FIG. 2B will be described.

### Connection/Disconnection of Agent to Cyber-Vehicle Room

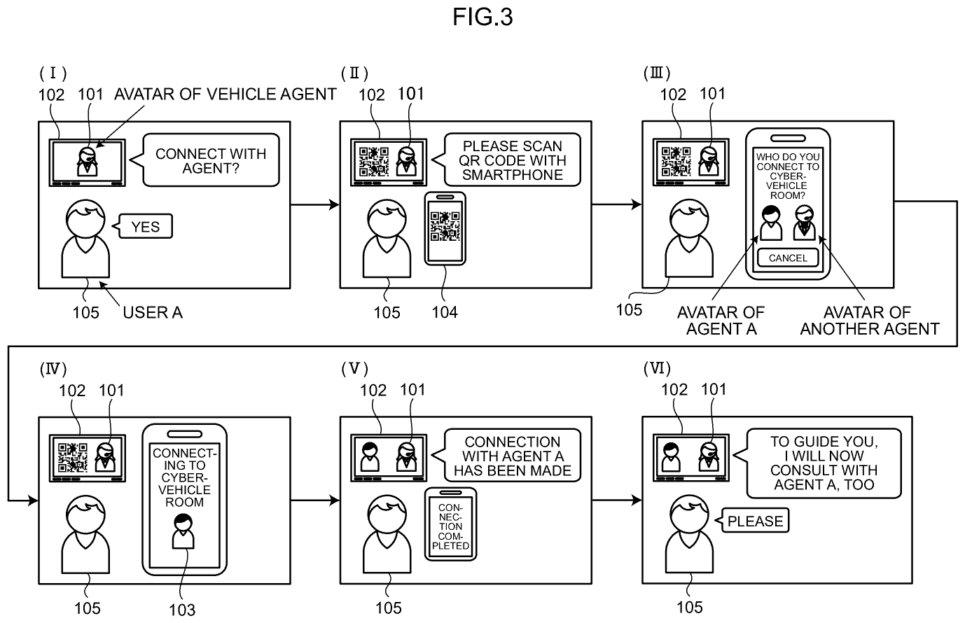

With reference to FIGS. 3 to 8, an example of a connection processing according to the embodiment of causing an agent of a user to get on and off (connect/disconnect) the cyber-vehicle room in accordance with the user getting on and off the real vehicle interior will be described below with respect to the connection processing outlined in FIG. 2B.

FIG. 3 is a diagram for describing an example of connecting an agent to be used by a user to the human-agent interaction system 100 according to the present embodiment. In this example, an example in which a user A 105 reads a QR code (registered trademark) for accessing the vehicle agent 101 or the cyber-vehicle room using the information terminal A 104 will be described. Hereinafter, description will be made in chronological order.

First, in (I), an avatar of the vehicle agent 101 is displayed on the UI unit 215 of the in-vehicle system 102. The vehicle agent 101 asks the user A “connect with the agent?” or the like, and confirms whether the user A has an intention to connect the agent of the user A to the vehicle agent 101 (or cyber-vehicle room, the same applies hereafter). In response to this question, the user A replies “Yes”, replying that the user A is willing to do so.

Next, in (II), the vehicle agent 101 displays a QR code including access information for connecting the agent of the user to the vehicle agent 101 on the UI unit 215 of the in-vehicle system 102 on the basis of the intention of the user. The vehicle agent 101 instructs the user A 105 to read the QR code, “Please scan the QR code with a smartphone”. The user A 105 activates the application installed in the information terminal A 104 and reads the QR code.

Next, in (III), the application reads the access information about the connection destination included in the QR code (for example, connection information to an online meeting, connection information indicating a specific chat channel, and the like), displays “Who do you connect to the cyber-vehicle room?” on the screen of the information terminal A 104, and causes the user A 105 to select which agent among some agents used by the user is to be connected. The screen is for selecting from two avatars of the avatar of the agent A 103 capable of autonomously responding using the preference and past history of the user A 105 and the avatar of the agent used for other specific purposes. The user A 105 selects the avatar of the agent A 103 and designates the agent A 103 as an agent to be connected to the cyber-vehicle room. Note that the agent used for other specific purposes is, for example, an agent used for assisting the study and work of the user A.

Next, in (IV), the application is trying to make the agent A 103 of the user connected according to the access information to the cyber-vehicle room included in the QR code. For the user A 105, information indicating that the agent A 103 is going to connect to the cyber-vehicle room of the vehicle is displayed on the screen of the UI unit 205 of the information terminal A 104 to make it easy to grasp the state.

Next, in (V), each of the applications of the vehicle agent 101 and the information terminal A 104 detects that the agent A 103 has been connected to the cyber-vehicle room, and notifies the user of the detection. The vehicle agent 101 is uttering, “Connection with agent A has been made”, and characters “connection completed” are displayed on the screen of the UI unit 205 of the information terminal A 104. As a result, the user A understands that the vehicle agent 101 (or the cyber-vehicle room) and the agent A 103 are connected and direct interaction becomes possible.

Next, in (VI), on the basis of the fact that the vehicle agent 101 has been able to connect to the agent A 103, “To guide you, I will now consult with the agent A, too” is uttered. This means that the vehicle agent 101 makes recommendations, proposals, selections, or decisions for the user A on the basis of the opinion or evaluation of the agent A 103 in various tasks regarding the vehicle and the vehicle interior, such as selection of a further route, selection of a stop-by place such as a sightseeing spot or a restaurant, selection of content to be reproduced in the vehicle interior, control of air conditioning, lighting, seat angle, and seat temperature for the user A. The user A who understands this consents to the vehicle agent 101, saying “please”, and requests the processing.

An example of a series of procedures of causing the in-vehicle system 102 to display the connection information to the cyber-vehicle room (or the vehicle agent 101) in the form of the QR code, and causing the user to read the connection information via the application of the information terminal to connect the agent of the user has been described in a diagram.

Note that, instead of reading the QR code, the in-vehicle system 102 may perform personal identification with the face or voice of the user A 105, other biometric information, a gesture, or the like, and connect the agent A 103 to the cyber-vehicle room when the user A 105 gets on the vehicle. Similarly, the in-vehicle system 102 may disconnect the agent A 103 from the cyber-vehicle room when the user A 105 gets off the vehicle. This is also to prevent a mismatch between the pieces of information received by the user A 105 and the agent A 103 caused by the agent A 103 remaining in the cyber-vehicle room even though the user A 105 gets off the real vehicle interior.

Note that the information terminal A 104 may automatically connect the agent A 103 to the cyber-vehicle room by using detection of wireless communication information transmitted by the in-vehicle system 102 (SSID of WiFi for the interior of the vehicle, MAC address or link key of Bluetooth (registered trademark), and the like) as a trigger. In a case where the access information about the cyber-vehicle room is fixed, it can be implemented by recording the access information when the application was connected in the past in the memory 204.

Note that the information terminal A 104 may be touched to the NFC included in the vehicle to read the access information to the cyber-vehicle room, and the agent A 103 may be automatically connected to the cyber-vehicle room.

The human-agent interaction system 100 according to the present embodiment includes a mechanism for making the agent A 103 used by the user A 105 to get on (be connected to)/get off (be disconnected from) the cyber-vehicle room in synchronization with the user A 105 getting on/off the real vehicle interior as described above. As long as this is implemented, the specific technical method may be performed in other embodiments including the above.

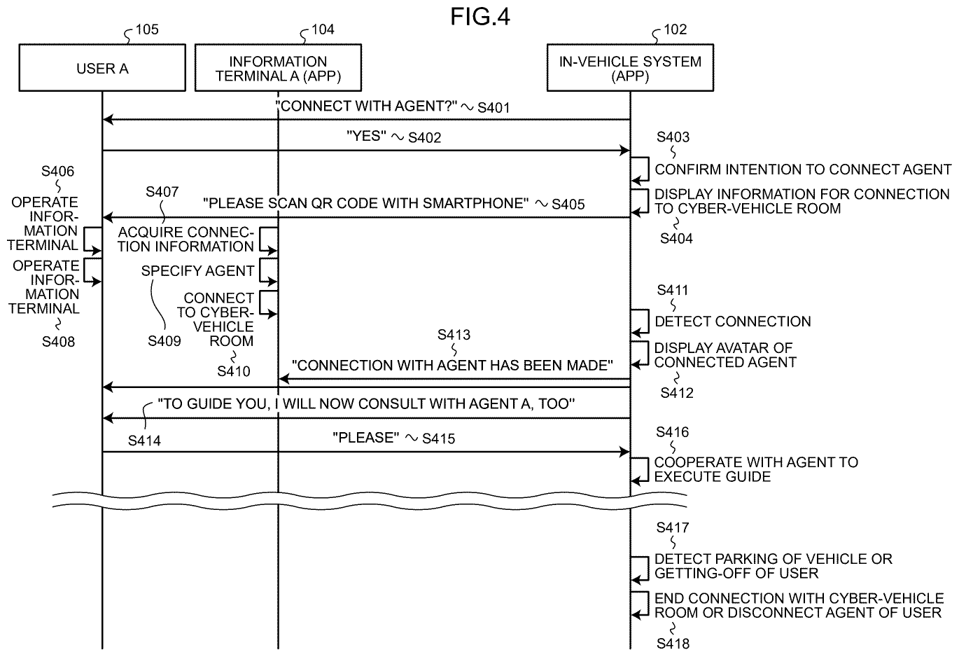

FIG. 4 is a sequence diagram illustrating an example of a procedure of connecting an agent to be used by a user to the human-agent interaction system 100 according to the present embodiment. The sequence of FIG. 4 includes both a scene in which the agent A 103 described in FIG. 3 is connected to the cyber-vehicle room and a scene in which the connection is released in synchronization with the user A 105 getting off the vehicle. In the following description, the user A 105 is used as in FIG. 3, but the same is applied to a case of other users (a user B 108 and the like). Note that, in the present specification and the drawings, units of processing in the sequence diagram and the flowchart diagram are denoted by reference numerals with S as an initial letter. In the present specification, for example, the notation is not as “step S401”, but simply abbreviated as “S401”.

First, confirmation is made to the user A 105 who gets in using the in-vehicle system 102 (or an application of the vehicle agent 101 that operates in cooperation with the in-vehicle system 102, the same applies hereafter), asking “connect with the agent?”, to confirm whether the user A 105 has an intention to connect the agent A 103 (or the information terminal A 104, the same applies hereafter) of the user A 105 to the cyber-vehicle room (step S401). When the user A 105 makes a positive response “Yes” to the question (S402), the in-vehicle system 102 confirms that the user A 105 has the intention to connect the agent A 103 (S403).

The in-vehicle system 102 displays connection information for another agent to connect to the cyber-vehicle room via the UI unit 215 of the in-vehicle system 102 (S404), and instructs the user A 105 to read the QR code displayed as “Please scan the QR code with the smartphone” using the application of the information terminal A 104 (S405).

The user A 105 reads the QR code using the application for using the agent A installed in the information terminal A 104 (S406). As a result, the application acquires connection information for connecting to the cyber-vehicle room (S407).

In a case where there are more than one agents used by the user A 105, an agent to be connected to the cyber-vehicle room is selected by touching an avatar or the like of the agent (S408). As a result, an agent to which the application is connected (the agent A 103 in this example) is specified (S409). Then, the application connects the agent A 103 to the cyber-vehicle room of the vehicle where it is possible to interact with another agent online (S410).

Once the in-vehicle system 102 detects that the agent A 103 has been connected to the cyber-vehicle room (S411), the in-vehicle system 102 displays the avatar of the connected agent A 103 on the UI unit 215 (S412), notifies the information terminal A 104 that the connection has been made via the service of the cyber-vehicle room, and notifies the user A 105 that the connection has been completed by uttering “The connection with the agent has been made” (S413).

The in-vehicle system 102 that has been successfully connected to the agent A 103 notifies the user A 105 that “To guide you, I will now consult with the agent A, too” (S414). In response to this, the user A 105 consents to it, saying “please”, and requests the subsequent processing (S415). Thereafter, the in-vehicle system 102 (or the vehicle agent 101) and the agent A 103 (alternatively, the information terminal A 104) communicate and cooperate with each other in the cyber-vehicle room, thereby providing a more valuable moving experience for the user A 105 (S416).

When the detection unit 213 including the in-vehicle camera and the like detects that the moving of the user A 105 ends, the vehicle arrives at the destination and is parked, the in-vehicle system stops, or the user A 105 gets off the real vehicle interior (S417), the in-vehicle system 102 disconnects the agent A 103 of the user A 105 from the cyber-vehicle room, or terminates the connection of the cyber-vehicle room itself, thereby disconnecting the connection with the agent A 103 (S418).

Note that, as the connection information to the cyber-vehicle room, a variable access destination or authentication code may be used from the viewpoint of security, or a fixed access destination or authentication code may be used for each vehicle in order to easily connect a device that has been connected once.

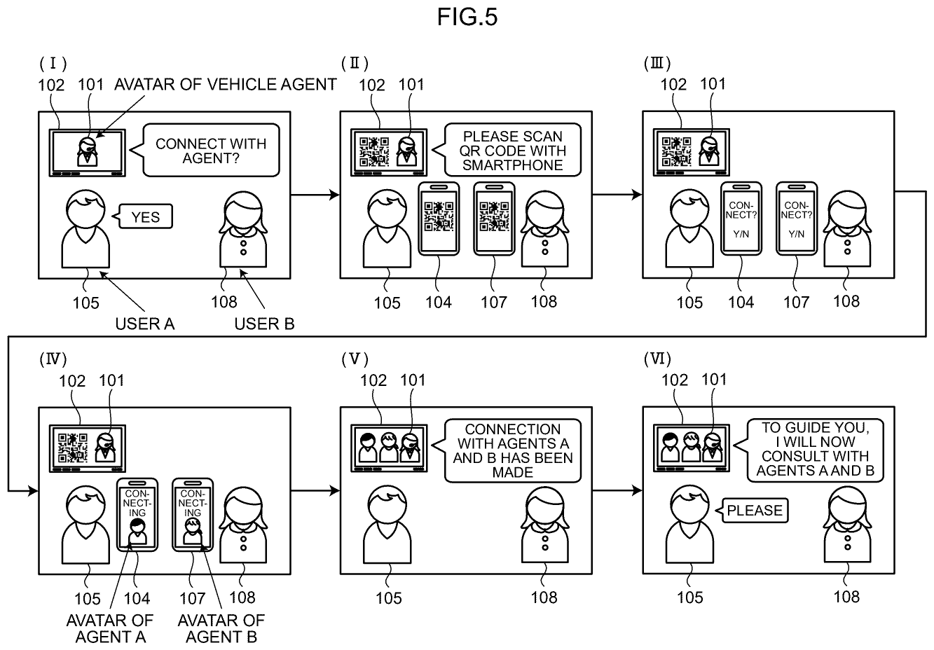

FIG. 5 is a diagram for describing an example of connecting an agent to be used by a user to the human-agent interaction system 100 according to the present embodiment. The difference from FIGS. 3 and 4 is that, two or more users are (simultaneously) connected. If the user B 108 uses the information terminal B 107 (agent B 106) to perform the same operation as the operation in which the user A 105 connects the agent A 103 to the cyber-vehicle room via the application of the information terminal A 104, the agent A 103 and the agent B 106 thereby can be connected to the cyber-vehicle room.

In addition, the processing of disconnecting the agent A 103 or the agent B 106 from the cyber-vehicle room is the same as the description in FIGS. 3 and 4, and thus is omitted.

There are some cases where more than one users get on the vehicle at the same time and move together. Therefore, if it is possible to allow each of agents of the users who get on the vehicle to get on (connect to) the cyber-vehicle room, it is considered that it is possible to recommend, select, and determine a route, a stop-by place, air conditioning in the vehicle interior, content to be reproduced in the vehicle interior, and the like so that each of the users who get on the vehicle can obtain a better moving experience. Therefore, the above-described mechanism that the agent used by each user can be connected to the cyber-vehicle room by displaying the QR code on the UI unit 215 and reading the QR code is considered to be extremely realistic and effective in such a new use case.

Note that the UI unit 215 of the in-vehicle system 102 displays the avatar of the connected agent when the agent connection is established. The display of the avatar of the agent may be continued while the avatar is connected to the in-vehicle system 102 (or the vehicle agent 101, or a cyber-vehicle room). As a result, the user of the agent can easily confirm that the agent has been connected to the cyber-vehicle room.

By connecting its own agent in this manner, it is not necessary to transmit or designate its own preference or detailed desires to the in-vehicle system by itself, and it is possible to leave it to its own agent. Therefore, there is an advantage that a psychological burden during moving by the vehicle is small, and an opportunity to obtain a notice or a new discovery that is not known to the user can be increased in an area that is not particularly known by the user.

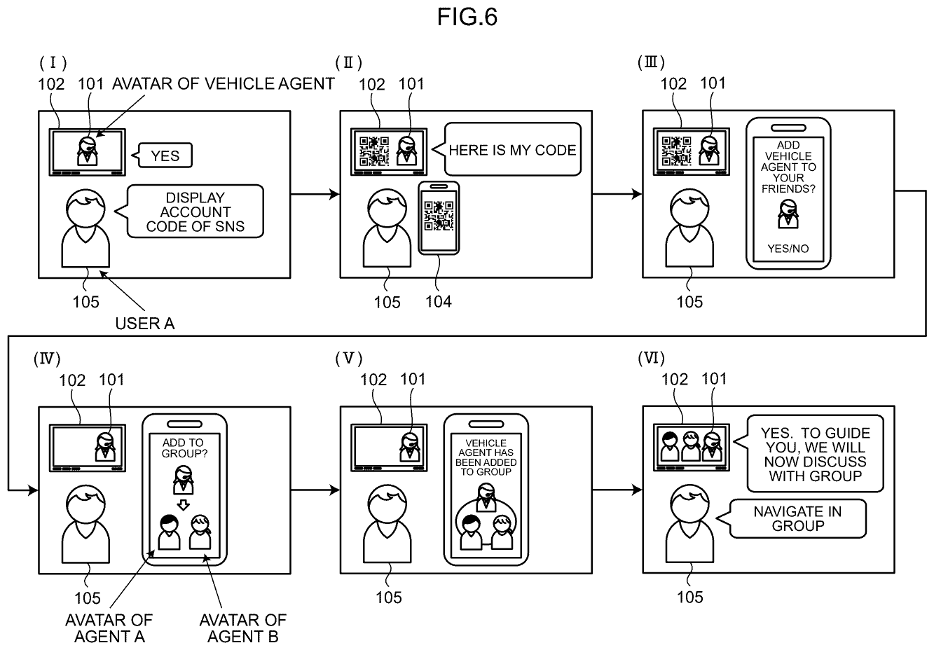

FIG. 6 is a diagram for describing an example of adding the human-agent interaction system 100 according to the present embodiment to a conversation group in which an agent used by the user participates.

The present embodiment is partly different from the embodiment in which the agent is connected to the cyber-vehicle room described above (hereinafter, Embodiment-Connection Processing A), but is an embodiment in which the vehicle agent 101 (temporarily) participates in a group of a social networking service (SNS) in which the agent A 103 of the user A 105 participates, thereby implementing the interaction between the agents (hereinafter, Embodiment-Connection Processing B).

With respect to the Embodiment-Connection Processing A described above in which the personal AI agent corresponding to the user is caused to participate in the virtual space in which the vehicle agent 101 corresponds or already resides, the Embodiment-Connection Processing B is different in that the vehicle agent 101 is invited to participate in the SNS group in which the personal AI agent already participates.

Note that, although it has been described here that the vehicle agent 101 is invited to the group of the SNS in which the agent A 103 participates, the present disclosure is not limited to this, and the vehicle agent 101 may be invited to a group of the SNS in which the user A 105 itself participates and the agent of the user A 105 does not participate. In that case, the user A 105 sets the agent A 103 on behalf of itself before, in the process of, or after causing the vehicle agent 101 to participate in the group. If there is already an SNS group that includes users in the real vehicle interior and does not include their agents, the vehicle agent 101 is made to (temporarily) participate in this group. In the case of this method, not all the users but only one of the users may operate the information terminal, so that there is an advantage that labor is reduced.

Note that, here, “temporarily participate” means that the vehicle agent 101 participates in the group with a condition of automatically excluding the vehicle agent 101 (namely, making the vehicle agent 101 exit) from the group in a case where one or more users in the real vehicle interior get off or in a case where the vehicle arrives at a destination. With this configuration, the vehicle agent 101 can participate in the group of the SNS only when necessary, and there is an advantage that concerns such as information leakage are suppressed. Moreover, the setting of the temporary participation condition may be provided by an application of the SNS, or the in-vehicle system 102 (or the vehicle agent 101) may leave (exit from) the group of the SNS by itself in a case where the participation of the vehicle agent 101 is no longer necessary or in a case where determination is made to be inappropriate.

First, in (I), in order to cause the vehicle agent 101 to participate in the SNS group in which the existing user A 105 or the agent A 103 participates, the user A 105 instructs “display an account code of the SNS (of the vehicle agent 101)”. In response to this, the avatar of the vehicle agent 101 consents, replying as “Yes”. For convenience of description, the SNS is simply used, but information that can identify which SNS may be transmitted to the vehicle agent 101.

Next, in (II), the vehicle agent 101 displays the account code information about its own SNS on the UI unit 215 of the in-vehicle system 102, and notifies the user A 105 as “Here is my code”. In response to this, the user A 105 activates the application of the information terminal A 104 and reads the account code information about the vehicle agent 101.

Next, in (III), the application of the SNS confirms whether to add the vehicle agent 101 as a friend. If there is no problem, the user A 105 touches Yes to add the vehicle agent 101 to friends

Note that, here, instead of adding the vehicle agent 101 as a friend, it may be registered as a temporary agent with a condition that the account may be stopped (invalidated) or excluded under a certain condition. For example, if the vehicle agent 101 is registered as a “vehicle agent” instead of a “friend”, it may be registered as a target to be automatically invalidated or excluded when a predetermined condition is satisfied on the basis of a positional relationship between the vehicle it currently gets on and the user, a use contract relationship, or the like.

Next, in (IV), a screen for selecting a SNS group in which the vehicle agent 101 is caused to participate is displayed on the information terminal A 104. In this screen, confirmation as to whether to make the vehicle agent 101 to participate in the group in which the agent A 103 and the agent B 106 are participating is requested. When the user A 105 presses a “OK” button (not illustrated) to indicate an intention of confirmation, the vehicle agent 101 is added to the target group.

Next, in (V), the fact that the vehicle agent 101 has participated in the SNS group including the agent A 103 and the agent B 106 is displayed on the screen of the information terminal A 104 and notified the user A 105 of the fact. Thus, the user A 105 knows that the vehicle agent 101 can autonomously interact with the agent A 103.

Next, in (VI), avatars of the vehicle agent 101, the agent A 103, and the agent B 106 connected in the SNS group are displayed on the UI unit 215 of the in-vehicle system 102. According to an instruction “navigate in group” from the user A 105, the vehicle agent 101 is requested to select or update the best route for the user A 105 and the user B 108 (not illustrated) who get on the real vehicle interior among the agents of the group. In response to this, the vehicle agent 101 says “Yes. To guide you, we will now discuss with the group”, and guides the users along the most appropriate route while interacting with the agent A 103 and the agent B 106.

As described above, the vehicle agent 101 may be caused to temporarily participate in the existing SNS group in which the user (or the agent used by the user) getting on the real vehicle interior participates. As the number of users to be connected increases, it becomes less troublesome for the user to connect to the vehicle agent 101 and the agent A 103. In addition, since the exchange between the agents is stored as a chat history in the familiar SNS group, it is possible to easily confirm what kind of consideration and interaction has been performed between the agents, and there is an advantage that it is easy to reduce and eliminate the concern and anxiety about the statement of the agent and the private information provision of the user.

Note that, the vehicle agent 101 (or the in-vehicle system 102) may notify the user A 105 of conditions for exclusion and withdrawal from the group, or invalidation of the account when the vehicle agent 101 participates in a group including the agent A 103 (or the user A 105). In that case, the user A 105 can more clearly understand how long the vehicle agent 101 stays in the SNS group and use the human-agent interaction system 100.

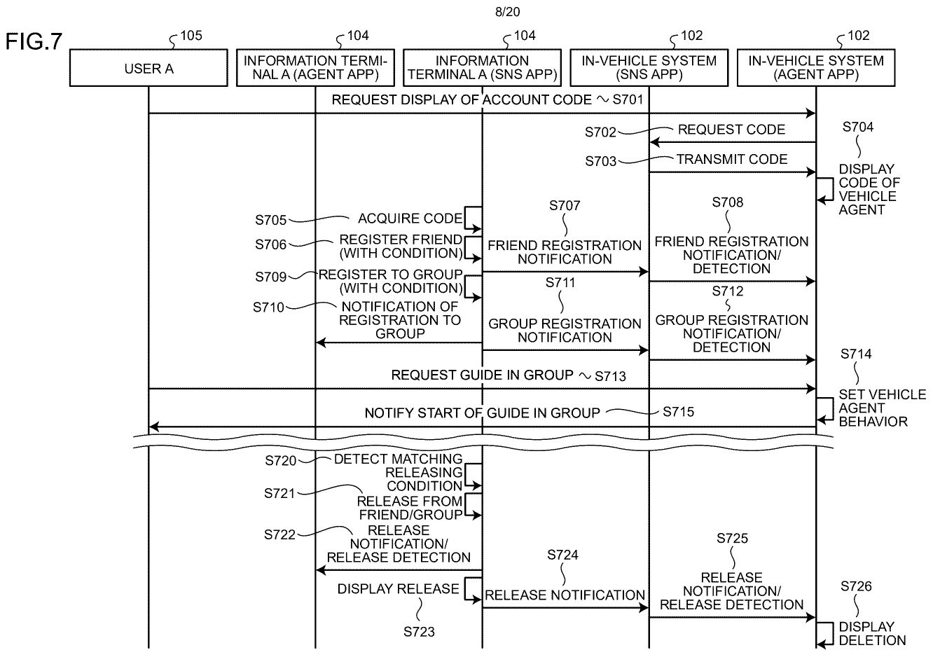

FIG. 7 is a sequence diagram illustrating an example of a procedure of adding the human-agent interaction system 100 according to the present embodiment to a conversation group in which the agent A 103 used by the user participates and excluding the system from the conversation group. The sequence of FIG. 7 includes both a scene in which the vehicle agent 101 is made to participate in the SNS group described in FIG. 6 and a scene in which the vehicle agent 101 is invalidated/withdrawn from the group on the basis of the invalidation of the account/withdrawal condition. In the following description, the user A 105 is used as in FIG. 6, but the same is applied to a case where another user (a user B 108 and the like) is used.

In order to additionally register the in-vehicle system 102 (or the vehicle agent 101) with the existing SNS group, the user A 105 requests the in-vehicle system 102 to display the account code of the vehicle agent 101 (S701). In response to this, (the vehicle agent 101 of, the same applies hereafter) the in-vehicle system 102 requests the account code of the SNS indicating the vehicle agent 101 from (an SNS application of; the same applies hereafter) the in-vehicle system 102 (S702). (The SNS application of) the in-vehicle system 102 that has received the request transmits the account code of the vehicle agent 101 to (the vehicle agent 101 of) the in-vehicle system 102 (S703). Then, (the vehicle agent 101 of) the in-vehicle system 102 displays an account code representing itself on the SNS application on the UI unit 215 (S704).

Note that, although it has been described that this processing is performed on the basis of a request from the user, it is also possible to detect that the user gets in the real vehicle interior and the processing may be automatically notified or displayed via the UI unit 215.

Next, the user A 105 operates (the SNS application of) the information terminal A 104 to read and acquire the account code displayed on the UI unit 215 (S705). Therefore, the user A 105 registers the vehicle agent 101 as a friend on the SNS application (S706). One or more conditions for invalidating or releasing the registration of the vehicle agent 101 as a friend (or vice versa, conditions for activation or continuing the registration) may be set. Since the registration of the vehicle agent 101 is temporary use particularly in the case of a sharing car or the like, and there is no reason to continue registration of the vehicle agent 101 to the SNS group including at least one or more users who get on the real vehicle interior or only all the users, even after the stop of use of this vehicle, a condition for invalidating or excluding the vehicle agent 101 from the friends and the group of the SNS may be set at the same time at the time of registration.

Once the vehicle agent 101 is registered as a friend on the SNS application, (the SNS application of) the in-vehicle system 102 is also notified of the registration via the operation service of the SNS application (S707). The notification from the SNS application is monitored, or detected by (the vehicle agent 101 of) the in-vehicle system 102 in API cooperation, whereby (the vehicle agent 101 of) the in-vehicle system 102 recognizes that the vehicle agent 101 has been registered as a friend on the SNS application of the user A 105 (S708).

Subsequently, the user A 105 registers the vehicle agent 101 registered as a friend to the SNS group in which the user A 105 (or the agent A 103) participates (S709). Similarly to the friend registration, one or more conditions for invalidating or releasing the registration of the vehicle agent 101 to the group (or conditions for activation or continuing the registration to the group) may be set. Note that the friend registration condition and the group registration condition are not necessarily the same. For example, in the friend registration, the registration is continued unless there is an explicit instruction from the user, but the registration to the group may be limited to the valid time which is the same as or equivalent to the use contract period of the vehicle, or a detailed condition such as temporarily invalidating while the user is getting off the vehicle may be applied.

Once the registration processing to the group using (a SNS application of) the information terminal A 104 is completed, (the agent A 103 of) the information terminal A 104 is notified of the registration (S710), and (the SNS application of) the in-vehicle system 102 is also notified of the registration via the operation service of the SNS application (S711). Thereafter, similarly to the friend registration in S708, the registration to the group is notified or detected by (the vehicle agent 101 of) the in-vehicle system 102 (S712).

In response to the connection between the vehicle agent 101 and the agent A 103, the user A 105 requests the in-vehicle system 102 (vehicle agent 101) to guide the user in the vehicle interior while jointly studying with other members of the registered group (including at least zero or more humans and one or more agents)(S713). In response to this, (the vehicle agent 101 of) the in-vehicle system 102 sets its own policy to recommend or determine the guidance of the vehicle in consideration of the preference or interest of the member of the registered group (S714). Then, it starts to guide the user or design a travel experience of the user in cooperation with a member of the group (S715). An embodiment in which the vehicle agent 101 designs guiding a vehicle and a moving experience of the user moving in the real vehicle interior in cooperation with another agent will be described in detail later.

After the registration, (the SNS application of) the information terminal A 104 (or the operation system of the SNS) determines whether an invalidation or releasing condition set at the time of friend registration (S705) and group registration (S709) on the SNS is satisfied, and detects that the condition is satisfied (S720).

(The SNS application of) the information terminal A 104 (or the operation system of the SNS) invalidates or releases registration of the vehicle agent 101 as a friend and/or a group (S721). The releasing is notified to or detected by (the agent A 103 of) the information terminal A (since the processing is similar to that in S722 and S708, the description thereof is omitted), and is also notified to the user A 105 via the UI unit 205 of (the SNS application of) the information terminal A 104 (S723).

The releasing is also notified to (the SNS application of) the in-vehicle system 102 via the operation service of the SNS application (S724). Then, that effect is notified or detected by (the vehicle agent 101 of) the in-vehicle system 102 (since the processing is similar to that in S725 and S708, the description thereof is omitted.). In response to this, (the vehicle agent 101 of) the in-vehicle system 102 notifies the user A 105 via the UI unit 215 that the vehicle agent 101 has been deleted from the SNS application of the user A 105 or from the group therein (S726).

The above is the description of the embodiment in which the agent of the user gets on and off the cyber-vehicle room in synchronization with the user getting on and off the vehicle (real vehicle interior). In order to cause the vehicle agent representing the vehicle and each agent representing each user getting on a real vehicle interior to perform cooperative operation, an embodiment of connecting to a cyber-vehicle room in which easy interaction is possible and an embodiment of invalidating or disconnecting when it is unnecessary have been described on the basis of an example.

Note that, here, as a method of connecting the agent of the user who gets on the vehicle to the in-vehicle system 102 (or the vehicle agent 101), a method of connecting using the access information about the online meeting room or the account information about the SNS has been described. However, a condition that devices in which the agents to be connected operate (the information terminal A 104, the information terminal B 107, and the in-vehicle system 102) are less than a predetermined distance may be set as a condition of connection using a positioning method such as GPS. It is considered that the security of the connection can be enhanced by using such a positional relationship as a connection condition.

Alternatively, in a case where the information terminal A 104 or the information terminal B 107 knows the access information to the in-vehicle system 102 (vehicle agent 101), it may be detected that the information terminal is sufficiently close to the in-vehicle system 102 by using near field communication (WiFi, Bluetooth, NFC, etc.) or a position measurement technology such as UWB or GPS, and the connection confirmation may be displayed on the screen of the UI unit 205 of the information terminal or notified to the user by voice or vibration using the detection as a trigger. Similarly, it may be detected that the distance between the vehicle and the information terminal is a predetermined distance or more, and a confirmation for releasing the connection may be obtained via the UI unit 205 with the detection as a trigger. In addition, in a case where the distance is further than the predetermined distance, or the state continues for a predetermined time or more, the connection may be automatically released.

### Joint Study and Recommended Candidate Selection between Agents in Cyber-Vehicle Room

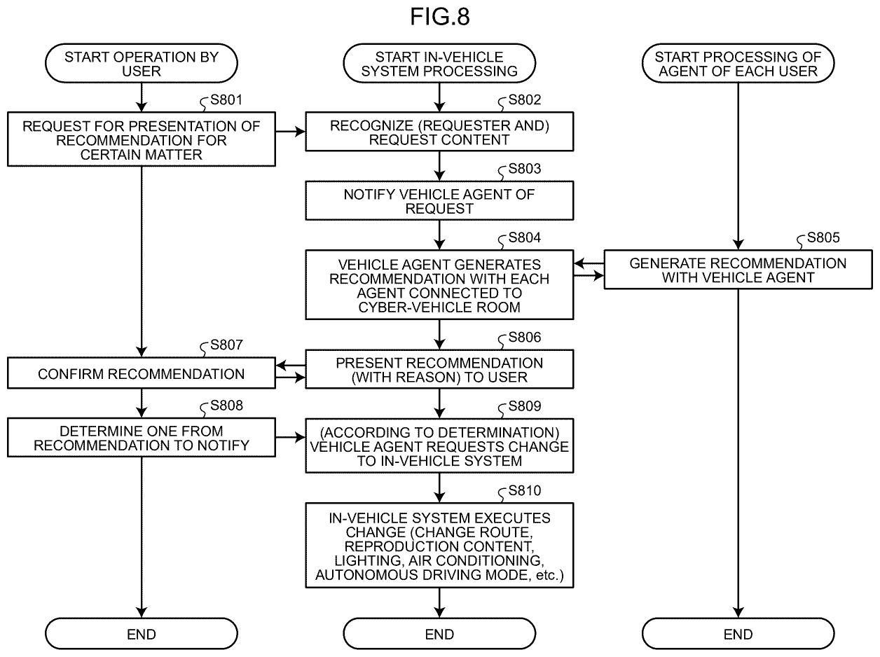

Hereinafter, with reference to FIGS. 8 to 11, a specific description will be given of the first embodiment of the cooperative operation related to the vehicle moving between the vehicle agent 101 and the connected agent in the consensus building processing and the operation processing outlined in FIG. 2B, various joint studies and the formulation of a recommendation plan (proposal) to the user, and the operation processing related to the vehicle moving with respect to the adopted recommendation (proposal) (hereinafter, referred to as embodiment-consensus building processing A and operation processing A).

FIG. 8 is a sequence diagram with a partial flowchart illustrating an example of a procedure of processing in which, in the human-agent interaction system 100 according to the present embodiment-consensus building processing A and operation processing A, a vehicle agent narrows down candidates to be recommended to a user by using an agent of each user, presents the candidates to the user, causes the user to determine acceptance or rejection of the candidates, and reflects the determination in an in-vehicle system.

First, the user (for example, the user A 105) requests the in-vehicle system 102 (or the vehicle agent 101) to present a recommendation plan regarding a certain matter (S801).

The certain matter means various matters that take time and effort to be investigated, analyzed, and compared in order for the user himself/herself to determine one candidate considered to be the best or optimal for the situation of the user at that time from among a large number of candidates not only within the knowledge of the user but also outside the knowledge.

Typical examples include a route selection from a current location to a destination, a sightseeing spot that the user wants to visit, food and drink that the user wants to eat/drink or a restaurant thereof, a shop that handles a product that the user wants to purchase, a parking space that the user wants to use at a waypoint/destination, music content that the user wants to listen to, video content that the user wants to see, and the like. Since there are a large number of options, it is difficult to recognize the entire candidate without missing any candidate, and it is difficult to compare and evaluate the candidates without omission, and any option is a matter that can often occur when the vehicle moves.

Moreover, in reality, with respect to each candidate, it is desirable to confirm whether the candidate is currently available (for example, business hours of a restaurant, traffic congestion, availability of a parking lot, and the like), whether all users who are going to experience the candidate together are curious or interested, and how much the cost for the candidate is required (for example, travel time and cost for each route candidate, and the like), but a huge amount of research is required on a steady basis. Therefore, there has been no method of finding a candidate satisfactory to the user who is driving or moving, which has been practically successfully implemented in the past.

With the progress of the technology of the generative AI, it has become possible to exchange with the AI in a chat form using a prompt. However, in particular, in a case where more than one users get in a real vehicle interior, it is not possible to realize that a recommendation plan is immediately narrowed down and proposed with respect to a designated matter while taking into consideration not only the preference and interest of each user but also a traffic condition that changes in real time. It is considered that one of the main factors is that it takes a lot of time and effort to prepare input data to the generative AI. It is still troublesome to prepare and execute a prompt for each destination candidate and study such a matter with the AI in the chat form, such as whether the matter follows the preference and interest of each user or whether the facility is available at the time of arrival at the destination, and it is not realistic. The human-agent interaction system according to the present embodiment solves this problem by using the generative AI, and aims to instantaneously perform evaluation between an agent as a substitute for the user in the real vehicle interior and a vehicle agent as an alternative for the vehicle, taking real-time information inside and outside the vehicle into consideration from among a large number of options for a certain matter, select a candidate optimal for the user, and present the candidate to the user. This makes the user's moving experience richer than ever and full of new discoveries.

The in-vehicle system 102 that has received the request from the user individually identifies the requester (one of the users in the vehicle interior) who has made the request, and recognizes the request content on the basis of the utterance (S802). For example, the individual identification of the requester may be specified by analysis of lip synchronization with the face video at the time of utterance, estimation of the utterance position using a microphone array, individual identification using a voiceprint, or the like. If the request is a verbal request, the request content may be made by voice recognition. The individual requester is identified in order to notify an agent connected to the cyber-vehicle room of a requester(s) in the real vehicle interior who was/were speaking. By specifying the requesters and the request content in pairs, the amount of information input to the agent increases, and the possibility of extracting an appropriate answer from the agent can be increased. Note that specifying the requester is not indispensable, and for example, only a text of a result of voice recognition indicating the request content may be transmitted to an agent connected to the cyber-vehicle room.

The in-vehicle system 102 that has recognized the request content notifies (transmits) the identification information about the requester and the request content of the requester (for example, text data subjected to voice recognition) to the vehicle agent 101 (S803). The notification may be made via a virtual conference room (that is, the cyber-vehicle room) on the Internet in which a video, an audio, an input text, and the like of the participant can be shared among the participants by a mechanism similar to that of the online conference. Alternatively, a mechanism for sharing a video, an audio, an input text, and the like of a participant belonging to a specific SNS group among participants in the group may be used and notified by a mechanism similar to the SNS group.

The vehicle agent 101 that has received the notification generates a recommended candidate for the matter requested by the user together with the agent connected to the cyber-vehicle room (S804). This step is performed simultaneously with a step (S805) in which the agent that has received the study request from the vehicle agent 101 creates a recommendation plan in cooperation with the vehicle agent 101. Details of the processing steps S804 and S805 will be described later.

The term “cyber-vehicle room” is used as a term meaning a digital virtual space in which two or more agents are connected via the network 109, and is not limited to a specific connection form such as an online meeting room or a group of SNS as described above.

The vehicle agent 101 that has generated the recommended candidate through the joint study with the agent presents one or more of the recommended candidates together with the reason for recommending the one or more recommended candidates to the user in the real vehicle interior via the UI unit 215 (S806). It is not indispensable to present the reason for recommendation together. This step will be described in detail later.

The user confirms the recommended candidate via the UI unit 215 (S807). In a case where the user does not accept the recommended candidate, the vehicle agent 101 may be instructed to display the next recommended candidate (arrow returning from S807 to S806), the vehicle agent 101 may present the next recommended candidate to the user with a reason (S806), and the user may repeatedly confirm them (S807).

In this manner, the user finally determines one from the candidates recommended by the vehicle agent 101, and notifies the vehicle agent 101 of the determined candidate (S808). In accordance with the determination, the vehicle agent 101 instructs the in-vehicle system 102 to perform setting or change (S809).

The in-vehicle system 102 instructed to perform the setting or the change executes the setting or the change (S810). Representative examples of the setting or change instructed to the in-vehicle system 102 from the vehicle agent 101 include a route or a parking lot managed by the navigation system, content reproduced in the vehicle interior, lighting and air conditioning in the vehicle interior, and a mode of autonomous driving (for example, a sports driving mode, an eco-driving mode with low environmental load, a low cost driving mode for suppressing the driving cost to the destination, an automatic tracking mode for continuously following the immediately preceding vehicle, and the like) in the case of an autonomous driving vehicle. Further, the autonomous driving is not limited to the fully autonomous driving of level 5. For example, a lane keeping mode and a cruising mode in which the autonomous traveling is released when the brake is stepped on, and a mode of less than level 5 in which the autonomous traveling is limited only in the expressway are included. In addition, automated valet parking in which automatic parking is performed from the vicinity of the destination to a parking lot is also included.

For example, in a case where a new place to stop by (sightseeing spot or restaurant) is added, the vehicle agent 101 transmits a request for addition of a waypoint to the navigation system. The navigation system that has received this adds a new waypoint, the route is searched again, and a navigation instruction is given along the new route. Alternatively, in the case of an autonomous driving vehicle, the calculation unit 212 drives the control unit 216 in accordance with the new route to cause the vehicle to autonomously travel along the new route. A specific example of this step will be described later.

In this way, the vehicle agent 101 and each agent connected to the cyber-vehicle room jointly study the recommendation plan for the matter specified by the user, and present the recommendation plan to the user together with the reason, so that the user can facilitate selection and decision making more suitable or appropriate for the user from options including a huge amount of unknown information. As a result, the human-agent interaction system 100 can implement a service that increases the moving experience value of the user.

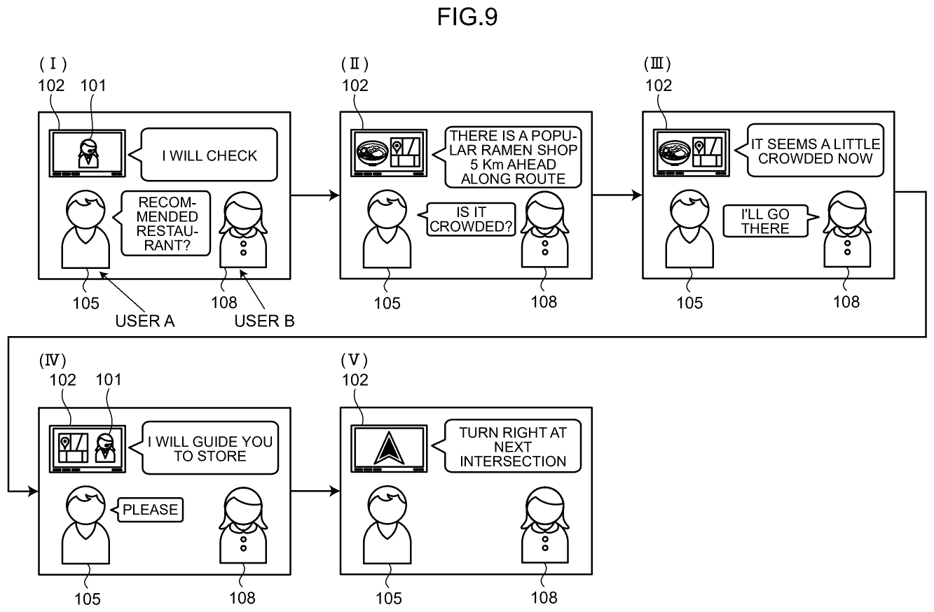

FIG. 9 is a diagram illustrating an example in which, in the human-agent interaction system 100 according to the present embodiment, a vehicle agent narrows down candidates to be recommended to a user by using an agent of each user, causes the user to determine acceptance or rejection of the candidates, and reflects the determination in the in-vehicle system 102 (navigation system). This is a specific example of the procedure of the processing described with reference to FIG. 8.

First, in (I), the user A 105 asks a question about “recommended restaurant?” to the in-vehicle system 102 (or the vehicle agent 101). In response to this, the vehicle agent 101 responds “I will check”, and selects a recommended candidate with an agent connected to the cyber-vehicle room.

Next, in (II), the selection of the recommended candidate is completed, and the vehicle agent 101 presents a dish video of a popular ramen shop and a route map to the shop to the user in the real vehicle interior via the UI unit 215 while notifying that “there is a popular ramen shop 5 km ahead along the route”. In order to select the recommended candidate, the vehicle agent 101 and the agent A 103 and the agent B 106 connected to the cyber-vehicle room extract and evaluate a restaurant that more closely matches plural conditions, and organize information as the recommended candidate.

The “restaurant that more closely matches plural conditions” refers to, for example, a restaurant that more satisfactorily satisfies two or more conditions, such as being at a place where the user can stop by from the currently set route, being opened at the current time or the estimated time of arrival, being able to be reserved at the estimated time of arrival, determined by the agent connected to the cyber-vehicle room to match the preference of the corresponding user, determined by the agent connected to the cyber-vehicle room that the corresponding user has registered as the curiosity target in the map or the SNS information, being highly evaluated by the user, being introduced in a popular medium, being a particularly famous dish or restaurant in an area including the current location, and the like.

If the plural conditions are roughly classified, the conditions include that the candidate to be recommended is in an available state close to the current position, is in accordance with the preference and curiosity of the user in the real vehicle interior, and has high evaluation from a third party. Among them, in a case where it is difficult to evaluate whether or not the condition matches the preference or the curiosity of the user in the real vehicle interior, the degree of coincidence between the preference information or the curiosity information about the user and each candidate target that can be accessed by the agent used by the user may be quantitatively evaluated.

To the ramen shop recommended by the vehicle agent 101, the user A 105 asks a question about the current congestion status of the shop, “Is it crowded?”. This represents a scene in which the user confirms information insufficient for determining the candidate recommended by the human-agent interaction system 100 as the recommended candidate.

Next, in (III), in response to the question, the vehicle agent 101 confirms the congestion status of the restaurant (via a service indicating the congestion status on the network) and replies “It seems a little crowded now”. In response to this, the user B 108 expresses an intention to stop by the ramen shop which is the recommended candidate, saying “I'll go there”.

Next, in (IV), the vehicle agent 101 that has obtained the final decision of the user responds “I will guide you to the store”, and notifies the user in the real vehicle interior that it will guide the user through the route to the ramen shop. The user A 105 hears the message and makes a positive response such as “please”.

Next, (V) illustrates a state in which (the navigation system of) the in-vehicle system 102 guides the route to the ramen shop determined. This means that the processing (information display in the UI unit 215) is taken over from the application of the vehicle agent 101 to the application of the navigation system in the in-vehicle system 102.

Note that, although the display on the UI unit 215 of the in-vehicle system 102 is switched to the navigation system to guide the route, the application of the vehicle agent 101 and the application of the navigation system may operate simultaneously on the in-vehicle system 102, and the guide may be continued using the voice of the vehicle agent 101 to guide the user the route to the ramen shop while referring to and displaying the map near the current location displayed by the navigation system.

In order to determine a restaurant to stop by while moving in a vehicle, it is necessary to consider various conditions as described above, and in reality, it takes a lot of time and effort. Therefore, in general, the user makes a decision based on a small amount of information. However, if there is this service in which an agent that knows the preference of the user and can autonomously study as a substitute for the user and a vehicle agent that understands the situation of the vehicle and the recommended candidate perform a cooperative operation to select the recommended candidate in an easy-to-understand manner for the user in the real vehicle interior, it is considered that an optimal selection can be made in selecting not only a restaurant to stop by while moving, but also a sightseeing spot or a route to the place that has not been possible in the past.

In addition, it is considered that the human-agent interaction system 100 is highly convenient in that not only the recommended candidate can be selected and proposed on the basis of the request of the user, but also the additional search for supplementary information for the final determination of the user, and the final determination matter can be instructed and reflected in each function of the vehicle. It is considered as effective that there is no troublesome labor for the user to operate the navigation system and add the ramen shop as a waypoint after the user decides to stop by the ramen shop as in the above example not only from the viewpoint of improving the moving experience but also from the viewpoint of changing the user's behavior on the basis of information provision.

Note that, although it has been described here that a recommended candidate is proposed in response to an inquiry from a user, the present disclosure is not limited thereto. For example, in a case where the agent of the user determines that there is a place that very well matches the preference or curiosity of the user around the current location where there is no or little history of user visits, the agent may notify the user (or the vehicle agent 101) of the fact.

When the agent notifies the vehicle agent 101, the agent may request the vehicle agent 101 to notify the user by giving a name of a target place, a simple description regarding the place, and an introduction image (or link information thereof). Upon receiving this information, the vehicle agent 101 notifies the user that the place is nearby on the basis of the received information via the UI unit 215.

Note that the above-described voluntary information provision from the agent may be performed only when the user visits an area where there is no or little visit history of the user, may be set in advance as to whether the user desires/does not desire the voluntary information provision of the agent, or may be implemented by notifying/requesting the agent in advance that the user desires/does not desire such voluntary information provision.

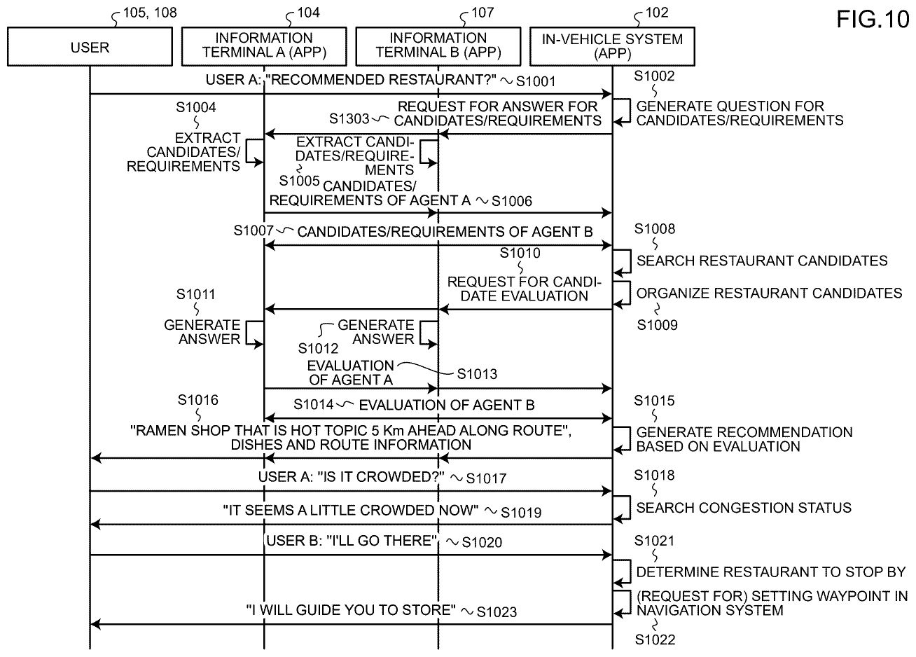

FIG. 10 is a sequence diagram illustrating an example of a procedure of processing in which, in the human-agent interaction system 100 according to the present embodiment, the vehicle agent 101 narrows down candidates to be recommended to a user by using an agent of each user, causes the user to determine acceptance or rejection of the candidates, and reflects the determination in an in-vehicle system (navigation system).

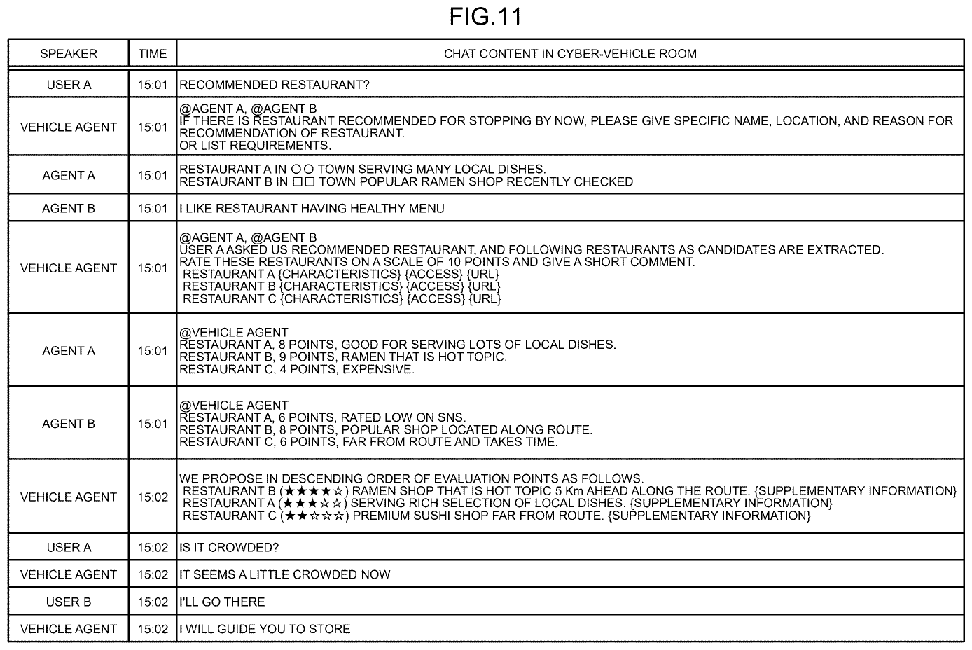

FIG. 11 is a diagram for describing an example of an interaction history between agents regarding processing in which, in a cyber-vehicle room of the human-agent interaction system 100 according to the present embodiment, a vehicle agent narrows down candidates to be recommended to a user by using an agent of each user, causes the user to determine acceptance or rejection of the candidates, and reflects the determination in an in-vehicle system (navigation system).

Since the scenes illustrated in FIGS. 10 and 11 are the same as those described in FIG. 8, the description will be made using the two drawings. In addition, the parts overlapping with the above description may be omitted.

The user A 105 asks a question about “recommended restaurant?” to the in-vehicle system 102 (hereinafter, alternatively, the vehicle agent 101) (S1001). Upon recognizing the request by voice and understanding the request content, the in-vehicle system 102 generates a question for getting candidates and requirements out of the agent connected to the cyber-vehicle room (S1002). Note that the interaction content from the user to the vehicle agent 101 may be shared with the agent connected to the cyber-vehicle room each time (not illustrated in FIG. 10. see first line in FIG. 11).

This question is, for example, a question using a natural language such as “@agent A, @agent B. If there is a restaurant recommended for stopping by now, please give the specific name, location, and reason for recommendation of the restaurant. Or list the requirements”. The “@agent A, @agent B” at the beginning is for designating (mention) agents that are expected to react to this message. As a result, the agent A 103 and the agent B 106 detect that the following message is addressed to themselves and some kind of response is necessary.

The vehicle agent 101 that has generated the above message transmits this message asking for an answer regarding a candidate or a requirement of the restaurant to the cyber-vehicle room or the agent A 103 and the agent B 106 connected to the cyber-vehicle room (S1003).

Each of (the agent A 103 of) the information terminal A 104 and (the agent B 106 of) the information terminal B 107 that have received this message extracts candidates and requirements of restaurants on behalf of the user on the basis of the messages received from the vehicle agent 101, and generates answers (S1004 and S1005).

Then, the agent A 103 transmits an answer to the candidate or requirement of the restaurant to the cyber-vehicle room or the agent B 106 and the vehicle agent 101 connected to the cyber-vehicle room (S1006).

This answer is, for example, an answer using a natural language such as “restaurant A in town serving many local dishes, restaurant B in □□ town a popular ramen shop recently checked”. For the message of the vehicle agent 101, two restaurants are recommended and include the name, location, and reason for the recommendation of each restaurant.

Note that “serving many local dishes” as the reason for recommendation for the restaurant A is an example of the reason for recommendation that the agent A 103 has found by searching the internet for a restaurant near the current location. Moreover, “a popular ramen shop recently checked” as the reason for recommendation for the restaurant B is an example of the reason for recommendation based on the past behavior history of the user A, namely, it is a ramen shop that the user A 105 has recently known on the SNS and registered.

Similarly, the agent B 106 transmits an answer to the candidate or requirement of the restaurant to the cyber-vehicle room or the agent A 103 and the vehicle agent 101 connected to the cyber-vehicle room (S1007).

This answer is, for example, an answer using a natural language such as “I like a restaurant having a healthy menu”, and is not a specific restaurant candidate but an answer to a requirement of a restaurant to be stopped by.

The vehicle agent 101 that has obtained these answers searches the Internet for other candidates for a restaurant to be added (S1008).

Note that the database or the website searched here may be provided by a third party. For example, candidates may be extracted from a search database/website of a restaurant provided by a third party. In this case, a special incentive design may be made between the third party and the operating company of the vehicle agent 101. In exchange for the vehicle agent 101 proposing a restaurant close to the current location in the database provided by the third party to the user in the real vehicle interior, advertisement fees may be paid from the third party to the operating company of the vehicle agent 101. In addition, in order to increase the curiosity of the user, a special discount coupon may be given for the introduction of these restaurants, and a coupon that can be used by the user with a discount price or some benefit may be given. These coupons may be in a form that can be read by an information terminal, and may be, for example, a QR code including a specific URL.

The vehicle agent 101 that has collected the restaurant candidates organizes the information on the restaurant candidates so that the agent connected to the cyber-vehicle room can evaluate the restaurant candidates (S1009). At the time of performing this arrangement or before and after the arrangement, the vehicle agent 101 may check whether each restaurant candidate is available at the expected arrival time of the vehicle on the Internet and leave only the available restaurant candidates as evaluation targets.

If the restaurant candidates are organized in this manner, the vehicle agent 101 requests the evaluation of the restaurant candidates from the cyber-vehicle room or the agent A 103 and the agent B 106 connected to the cyber-vehicle room (S1010).

This request is, for example, an evaluation request using the following natural language.

“@agent A, @agent B. User A asked us for a recommended restaurant, and the following restaurants as candidates are extracted. Rate these restaurants on a scale of 10 points and give a short comment.
Restaurant A {characteristics} {access} {URL}
Restaurant B {characteristics} {access} {URL}
Restaurant C {characteristics} {access} {URL}}”

Each of the restaurants A, B, and C is a name of a restaurant. {characteristics} is a sentence that briefly expresses characteristics of a corresponding restaurant. {access} is information indicating a moving time or a distance from a current location or a currently set route to a corresponding restaurant. {URL} is a URL of a website that introduces a corresponding restaurant.

Each of (the agent A 103 of) the information terminal A 104 and (the agent B 106 of) the information terminal B 107 that have received this message evaluates each restaurant on behalf of the user on the basis of the message received, and generates an answer with a short comment (S1011 and S1012).

Then, the agent A 103 transmits the generated answer to the cyber-vehicle room or the agent B 106 and the vehicle agent 101 connected to the cyber-vehicle room (S1013).

This answer is, for example, an answer using the following natural language.
“@vehicle agent
Restaurant A, 8 points, good for serving a lot of local dishes
Restaurant B, 9 points, ramen that is a hot topic
Restaurant C, 4 points, expensive”

Similarly, the agent B 106 transmits an answer including rates for the restaurant candidates to the cyber-vehicle room or the agent A 103 and the vehicle agent 101 connected to the cyber-vehicle room (S1014).

This answer is, for example, as follows.
“@vehicle agent
Restaurant A, 6 points, rated low on SNS
Restaurant B, 8 points, popular shop located along the route
Restaurant C, 6 points, far from the route and takes time”

In both the answer of the agent A 103 and the answer of the agent B 106, the “@vehicle agent” at the beginning is for designating the vehicle agent 101 that is expected to react to this message. As a result, the vehicle agent 101 detects that a clear reaction is required for the subsequent message.

Upon receiving these answers, the vehicle agent 101 selects/organizes the recommended candidates based on the evaluation result of the agent (S1015).

The arrangement of the recommended candidates may be shared with other agents in the cyber-vehicle room. For example, it can be organized using natural language as follows.

“We propose in descending order of evaluation points as follows.
Restaurant B (★★★★☆)
A ramen shop that is a hot topic 5 km ahead along the route {Supplementary information}
Restaurant A (★★★☆☆)
Serving a rich selection of local dishes. {Supplementary information}
Restaurant C (★★☆☆☆)
A premium sushi shop Far from the route {Supplementary information}”

The mark ★ is displayed by visualizing and displaying the quantitative evaluation result described later in an easy-to-understand manner, and the quality of the evaluation result between the agents is indicated in five levels as an example. The {supplementary information} is video information about a dish for introducing a corresponding restaurant, route information to the restaurant, URL of the restaurant, or the like.

Although details of selection of recommended candidates will be described later, when an evaluation point is obtained, a candidate having a higher total value may be preferentially recommended. In addition, the recommended candidate may be changed in the recommended priority order not only by the evaluation point but also by the reason of recommendation. In addition, when the vehicle agent 101 presents a recommended candidate to the user, not only the name of the recommended candidate but also a reason for the recommendation may be briefly indicated, and supplementary information such as a photograph and route information may be added.

Next, the vehicle agent 101 briefly presents a recommended candidate and a reason for the recommendation, “There is a ramen shop that is a hot topic 5 km ahead along the route”, and then notifies the user of the recommended candidate together with a dish photograph for supplementary explanation and route information via the UI unit 215 (S1016). That is, it is the form of proposal illustrated in FIG. 9 (II). Note that this notification may be shared with an agent connected to the cyber-vehicle room (in this example, the agent A 103 and the agent B 106) (not illustrated in FIG. 11).

On the other hand, the user A 105 says “Is it crowded?” to the vehicle agent 101, indicating concern about congestion of the restaurant (S1017). In response to this, the vehicle agent 101 acquires, from the external service, prediction information about the current congestion of the restaurant or the congestion of the expected arrival time (S1018). Then, the vehicle agent 101 replies to the user A 105 that “It seems a little crowded now” (S1019).

On the other hand, the user B 108 notifies the vehicle agent 101 of the determination of the restaurant that “I'll go there” (S1020). In response to this, the vehicle agent 101 determines the above-described ramen shop as the restaurant to stop by (S1021). Then, (the navigation system of) the in-vehicle system 102 is set or requested to set the above-described ramen shop as a waypoint (S1022). This setting request may be implemented by API cooperation from the application of the vehicle agent 101 to the application of the navigation system. Moreover, the user is informed that “I will guide you to the store” indicating that the user will be guided to the ramen shop (S1023). As a result, the user can know a suitable restaurant without having to search for the restaurant by himself/herself. In addition, when the restaurant is finally determined, the route guide to the restaurant is started, and a very smooth moving experience can be obtained.

For example, in a case where the vehicle is an autonomous driving vehicle such as a taxi driven in an unmanned manner such as a robot taxi, when the navigation system adds a new waypoint and sets a new route, an autonomous driving control system that drives and controls the control unit 216 for autonomous driving (one of software/functions operated by the calculation unit 212. Specifically, the driving assistance/autonomous driving control software 1908) detects this, or receives a notification indicating that the route has been updated from the navigation system, and drives and controls the control unit 216 in accordance with the new route to autonomously drive the vehicle. In this case, since no user in the real vehicle interior needs to drive, the user can move to the place only by determining the destination or the waypoint while interacting with the human-agent interaction system 100.

In the table of FIG. 11, identification information about the speaker, the time of the utterance, and the content of communication (text of chat) flowing in the cyber-vehicle room are illustrated. If the cyber-vehicle room is in the form of an online meeting room, this can be automatically recorded like meeting minutes and shared among agents. In a case where the cyber-vehicle room is in the form of a SNS group, the chat content is recorded as a conversation log of the group, and can be shared among the members of the group. Regardless of the embodiment of the cyber-vehicle room, the user can confirm later what kind of study and evaluation has been made between the agents. This is also useful in the sense that the user can later confirm whether the behavior of the agent that has provided information, opinion, proposal, or evaluation on behalf of the user has been as expected by the user, whether the information that the user is concerned about has not been inadvertently transmitted, or the like.

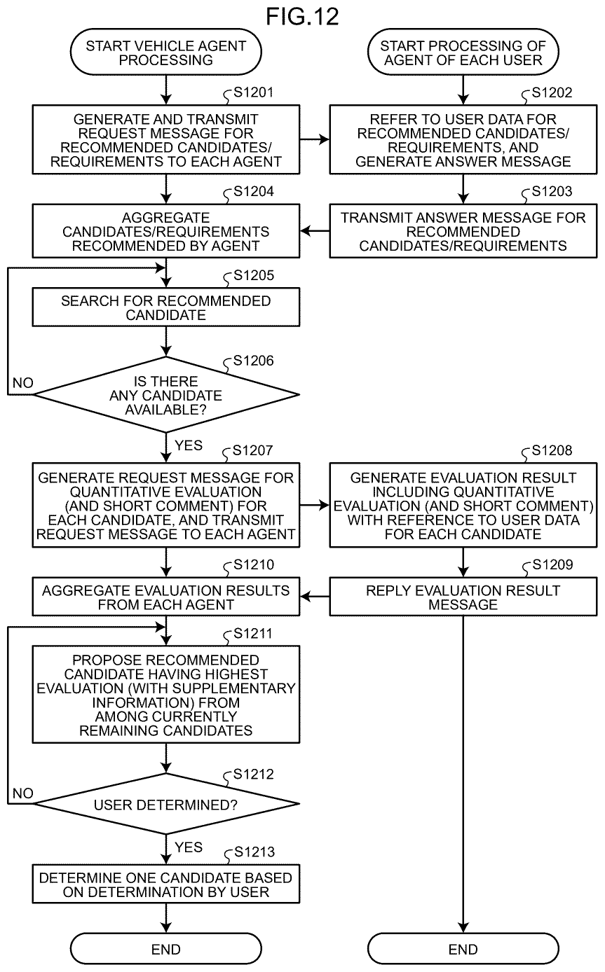

FIG. 12 illustrates different modes (embodiment-consensus building processing B and operation processing B) of the consensus building processing A and operation processing A of the embodiments of FIGS. 8 to 11 described above.

It is a flowchart diagram illustrating an example of a procedure of processing in which, in the human-agent interaction system 100 according to the present embodiment, the vehicle agent 101 narrows down candidates to be recommended to a user by using an agent of each user, and causes the user to make determination.

This processing is different from the processing in the conventional system in that the vehicle agent 101 performs the following five points.
P1) Proceed study with an agent that knows the user's preference
P2) In creating a recommended candidate, the recommended candidate is collected from each agent
P3) Cause each agent to quantitatively evaluate each recommended candidate
P4) Aggregate the evaluation results of each agent and suggest them to the user from the top candidates
P5) Propose the recommended candidate to the user with a reason for the recommendation and supplementary information

There is a large difference in that instead of completing the processing by moving one computer system or program as described above, a plurality of computer systems and programs (that is, the agents) cooperatively study the examination, the vehicle agent 101 progresses the examination and collects the examination result, an agent that knows the preference of the user in the real vehicle interior participates in the examination, and the agent that knows the preference of the user proposes the examination to the user including a reason recommended, and the like.

In the flowchart illustrated in FIG. 12, the processing of the vehicle agent 101 is illustrated on the left side, and the processing of the agent of each user connected to the cyber-vehicle room is illustrated on the right side. The processing in this figure is started when the vehicle agent 101 is requested to propose a recommended candidate from the user or receives a voluntary proposal from the vehicle agent 101 or another agent. In addition, a message is transmitted and received in the procedure of processing, but this is similar to the example of the message described in FIGS. 10 and 11, and the description thereof will be omitted.

First, the vehicle agent 101 generates a request message for submitting a candidate to be proposed for the current study theme or a requirement thereof to the agent of each user, and transmits the request message to the cyber-vehicle room or each agent connected to the cyber-vehicle room (S1201. See S1002 and S1003).

The agent that has received the request message generates a recommended candidate or requirement as an answer message with reference to data regarding preference or curiosity of the user (S1202. See S1004 and S1005). Further, the generated answer message is returned to the vehicle agent 101 or the cyber-vehicle room (S1203. See S1006 and S1007).

When the answer message is received, or when a predetermined time has elapsed from step S1201, the vehicle agent 101 aggregates the acquired candidates and requirements recommended by each agent (S1204). The aggregation of the candidates is processing of listing the candidates acquired from the agent so as not to overlap. In addition, the aggregation of the requirements is processing of listing the requirements acquired from the agent while arranging expressions so as to prevent semantic overlap or omission.

The processing from step S1201 to step S1204 corresponds to P1) and P2) described above. In a case where information in the SNS account followed by the user or history information browsed/registered on the network service can be used, it is possible to make a proposal more personalized to the user by utilizing these pieces of information. This can be achieved if the agent of the user is authorized to access the above information about the user. Alternatively, if there is information obtained by quantifying the degree of preference or curiosity of the user for a specific type/genre as the setting information about the agent, the information may be used.

Moreover, the vehicle agent 101 does not independently generate a candidate population, but collects the candidate population from agents connected to the cyber-vehicle room as a substitute for the user to form the population. This is in accordance with the user's preference and curiosity, leading to an increase in the possibility of giving a recommended candidate with a high satisfaction level. In this way, the proposal based on the preference and curiosity of the user utilizing the agent can have a proposal with high quality and accuracy unlike the proposal based on the evaluation of the third party who does not know the preference and curiosity of the user at all.

Next, the vehicle agent 101 searches via the network 109 whether there is an appropriate candidate other than the candidate acquired from the agent (S1205. See S1008). In the additional search for the candidate, the vehicle agent 101 may search for and add a new candidate from the database provided by the third party as described in step S1008. Detailed event information, campaign information, and the like of an area provided by a third party such as a travel agency or a regional organization are of course useful for the user, and may create an once-in-a-lifetime encounter, and also become an opportunity for the operating company of the vehicle agent 101 to obtain advertisement fees, and the possibility that the service can be continuously provided is increased.

The vehicle agent 101 checks via the network 109 whether all the collected recommended candidates are available around the expected arrival time of the vehicle (S1206. See S1009). If there is no available candidate, or if the number is less than the predetermined number, the processing proceeds to “No”, and a recommended candidate to be added is searched for and added via the network 109 (S1205). The vehicle agent 101 performs a search based on the list of requirements collected from the agent. On the other hand, when the number of available candidates is equal to or larger than the predetermined number, the processing proceeds to “Yes”.

Next, the vehicle agent 101 generates a request message for a quantitative evaluation and a short comment of the reason of the evaluation for each recommended candidate collected so far, and transmits the request message to the cyber-vehicle room or each agent connected to the cyber-vehicle room (S1207. See S1010).

The quantitative evaluation is requested for the sake of simplicity, objectivity, and fairness of aggregation processing. Since it is considered technically possible that the vehicle agent 101 ranks the priority from the qualitative evaluation, such a form may be adopted. However, in that case, it is not possible to eliminate the concern that the intention and bias of the vehicle agent 101 affect the evaluation. Therefore, a method in which the vehicle agent 101 determines the priority order of the recommendation in a form that can be simply calculated from the evaluation of the agent that is a substitute for the user without being added to the evaluation will be mainly described.

Note that the short comment is not indispensable, but in a case where the short comment can be acquired, the short comment can be presented as supplementary information in step S1211 to be described later, and can help the determination of the user.

The agent that has received the evaluation request message performs quantitative evaluation and short comment on each candidate with reference to the user's preference and curiosity information, and creates an evaluation result including the quantitative evaluation and the short comment (S1208. See S1011 and S1012). Further, each agent returns a message of the evaluation result created by each agent to the cyber-vehicle room or the vehicle agent 101 (S1209. See S1013 and S1014).

The vehicle agent 101 that has received the evaluation result message from each agent aggregates the evaluation results from each agent (S1210. See S1015). As described above, the aggregation method of the evaluation results may be a simple method. As in the above-described example, in a case where each of the recommended candidates is quantitatively evaluated on a scale of 10 points, and a short comment is given to the recommended candidate, a total value obtained by adding a score of the evaluation on a scale of 10 points to each of the recommended candidates by an agent that has answered the score may be set as a quantitative evaluation result of each agent for the recommended candidate, and the recommended candidate having a high score of the quantitative evaluation result may be recommended to the user with a high priority.

Note that, in a case where the evaluation score of the recommended candidate is not described or is invalid, a valid evaluation average score obtained by dividing a value obtained by summing the valid evaluation scores by the number of agents that have answered the valid evaluation score may be used. For example, a recommended candidate having a higher valid evaluation average score may be recommended to the user as a recommended candidate having a higher priority in descending order of the valid evaluation average score (descending order of priority).

Note that, in a case where a certain recommended candidate has received significantly low evaluation from one or more agents, such as evaluation of 3 points or less on a scale of 10 points, there is a possibility that the user of the agent that has given the evaluation may strongly dislike the recommended candidate. Therefore, the priority of the recommended candidate may be relatively lowered or may be excluded from candidates recommended to the user.

In a case where strong affirmation/denial is included in the short comment, the vehicle agent 101 may adjust the priority in consideration of the strong affirmation/denial. For example, in a restaurant where a lot of foods that the user is allergic to are served, it is conceivable that the agent describes “serving a lot of dishes containing allergy” in the short comment. As described above, unlike the presence or absence of preference or curiosity, in a case where there are restrictions on the user's health (allergy, calories, etc.), belief (such as religion), and creed (such as a vegan), the vehicle agent 101 may change or set the priority in accordance with not only the quantitative evaluation result but also the description content of the short comment or by prioritizing the short comment over the quantitative evaluation result.

The processing from step S1207 to step S1210 corresponds to P3) described above. Except for the case where there are strong restrictions on health, belief, and creed as described above, it is possible to easily count with fairness by requesting a quantitative evaluation and simply counting the scores.

In response to the determination of the priority of the recommended candidate, the vehicle agent 101 proposes a recommended candidate having the highest evaluation from among the currently remaining candidates to the user via the UI unit 215 (S1211. See S1016). In this proposal, the reason why the recommended candidate is recommended may be generated on the basis of the short comment of the agent and given as supplementary information. In addition, similarly, video information, audio information, distance information from a current location or a route, evaluation comments of a third party, and the like for introducing the recommended candidates may be added as supplementary information.

For example, in a case where the study theme is a sightseeing spot, the proposal may be made including one or more of the name of the sightseeing spot, the characteristics of the sightseeing spot, and the video of the sightseeing spot. In a case where the study theme is a restaurant or a retail store, the proposal may include one or more of the name of the store, the characteristics of the products/services handled by the store, and the video of the products/services handled by the store. In a case where the study theme is video/audio content, one or more of the name of the content, the characteristics of the content, and the video indicating the content may be included in the proposal. When the study theme is a route, one or more of the estimated travel time of the route, the estimated toll, the characteristics of the route, and the route displayed on the map may be included in the proposal. Note that the characteristics included in each proposal may include one phrase matching the user's curiosity or one phrase including evaluation by a third party based on the short comment.

The vehicle agent 101 (or the in-vehicle system 102) detects a response by any one or more of the user's speech, touch operation, expression, gesture, and the like via the detection unit 213, and determines whether or not the user has determined to adopt at least one of the currently proposed recommended candidates (S1212). In a case where a negative reaction of the user or a reaction for requesting another recommended candidate is detected, the processing proceeds to “No” and returns to step S1211, and a proposal is made from the second most recommended candidate. On the other hand, when it is detected that the user has decided to adopt (or select) the currently proposed recommended candidate, the processing proceeds to “Yes”.

In a case where the determination made by the user is detected, the vehicle agent 101 determines that the recommended candidate selected by the user has been finally determined (S1213), and terminates the processing.

The processing from step S1210 to step S1213 corresponds to P4) and P5) described above. The priority of recommended candidates is determined based on the evaluation result of the agent, and the recommended candidate is proposed to the user from the candidates having the higher priority with the reason for recommendation. Therefore, the user can easily understand the attraction of the recommended candidate and can easily select one candidate as the final candidate.

Details of an information leakage countermeasure of the consensus building processing according to the embodiment illustrated in FIG. 2A will be described below. In addition, user data and handling thereof will be described in detail.

### Information Leakage Countermeasure against Agent

In the above description, the connection form or system in which the vehicle agent 101 and each agent connected to the cyber-vehicle room can browse common information has been exemplified. With this connection form, symmetry of information is secured, and study and evaluation can be performed between agents with transparency. However, since each agent can hold or refer to the preference information and the behavior history information about the user, there is a concern that the agent arbitrarily transmits private information that the user does not want to disclose to the cyber-vehicle room or another agent connected to the cyber-vehicle room. Therefore, hereinafter, an embodiment regarding countermeasures against information leakage between agents connected to the cyber-vehicle room will be specifically described.

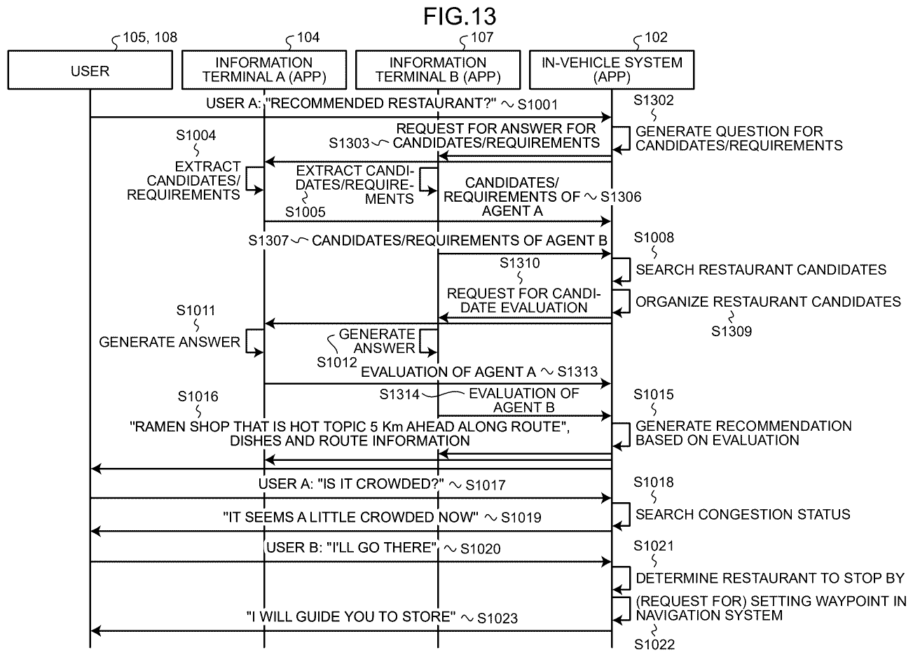

FIG. 13 is a sequence diagram illustrating an example of a procedure of processing in which, in the human-agent interaction system 100 according to the present embodiment, a vehicle agent narrows down candidates to be recommended to a user by using an agent of each user, causes the user to determine acceptance or rejection of the candidates, and reflects the determination in an in-vehicle system (navigation system).

FIG. 13 is exactly the same scene as FIG. 10 and is similar to the example of the processing procedure of the human-agent interaction system 100 illustrated in FIG. 10, and thus only the difference will be described. The different processing steps are those indicated in the S1300 series.

The processing from step S1302 to step S1307 is processing of collecting candidates/requirements for the study themes given from the agent of the user. In FIG. 10, as the cyber-vehicle room, it has been described that all the participants can access the same information, similarly to an online meeting room and a group chat of an SNS. On the other hand, in FIG. 13, the vehicle agent 101 and each agent exchange information in an individual chat format or exchange information between the two parties via a predetermined API. Therefore, private information included in the answer of each agent is not shared with the agent of another third party. Note that the cyber-vehicle room in which the vehicle agent 101 and each agent exchange information with each other in an individual chat format or exchange information between the two parties via a predetermined API, namely, the cyber-vehicle room in which the two parties can interact with each other according to the embodiment is an example of a cyber-private room.

The vehicle agent 101 adds “@agent A” to the candidates/requirements question message to indicate that this is a direct message (mention) to the agent A. The vehicle agent 101 individually transmits a request message to the agent in response to determining that exchange of information having a concern about being shared among agents connected to the cyber-vehicle room may occur. Therefore, if the message is a request message to the agent A 103, a message including no mention to other agents, such as “@agent A. If there is a restaurant recommended for stopping by now, please give the specific name, location, and reason for recommendation of the restaurant. Or list the requirements” is generated (S1302).

The vehicle agent 101 individually transmits the request message generated for each agent connected to the cyber-vehicle room (S1303). Alternatively, the request message is transmitted to the endpoint of each agent via the API. Note that, since the request message itself does not include information that invades privacy, the processing may be performed such that the same request message is transmitted to each agent connected to the cyber-vehicle room in a shared manner as in steps S1002 and S1003.

Next, the agent A 103 and the agent B 106 that have received the request message each extract candidates/requirements for the study theme on the basis of the request message (S1004 and S1005). This processing is the same as that in FIG. 10.

Next, the agent A 103 and the agent B 106 return the generated answer messages to the vehicle agent 101. There is a possibility that this answer message includes private information such as the aforementioned health, belief, creed, preferences, behavior history, etc. Therefore, each agent replies only to the requested vehicle agent 101 (S1306 and S1307).

In this manner, it is possible to prevent private information about any one of the users from being leaked to a third party agent other than the vehicle agent 101 and the agent when collecting candidates/requirements for the study themes. The user can also confirm that this mechanism works in this way using a chat history of the cyber-vehicle room or the like, and can use this service with security.

Thereafter, the same processing as described above is performed when the restaurant candidates are evaluated.

As described in step S1302, step S1309 of organizing the restaurant candidates is different from step S1009 in that the agent to be mentioned in the request message is only the agent that transmits the message.

As described in step S1303, step S1310 of the candidate evaluation request is different from step S1010 in that the request message is transmitted for each individual agent.

Steps S1313 and S1314 in which the agent returns the evaluation are different from steps S1013 and S1014 in that the agent returns only to the requested vehicle agent 101 as described in steps S1306 and S1307.

FIGS. 10 and 13 illustrate the same scene and have almost the same processing procedure, but in a case where there is privacy concern, the information communication between the agents is switched to individual communication, thereby eliminating the risk of information leakage to an unrelated third party agent.

It is assumed that a partner type agent capable of holding or referring to preference information, curiosity information, behavior history information, and the like of the user for each user is used in daily life. Therefore, for example, in a state where more than one agents are connected in a cyber-vehicle room and share all information, there is a risk that private information or sensitive information such as user's preferences and creed are shared regardless of the user's intention. Such a problem is a problem that has not existed in the past.

In a case where private information or sensitive information such as one's own preference or creed is conveyed to another person's agent, it is a problem that both the user who is an owner of the information and the agent of the user who has sent the information cannot control how the other person's agent handles the information. Therefore, in the present embodiment, when more than one (three or more) agents exchange information, in a case where private information or sensitive information about a user is handled, communication is performed only between a minimum necessary number of (for example, two) agents, and a connection form in which a third party agent is excluded is adopted.

Moreover, the present embodiment describes a case where a user uses an agent while moving in a vehicle. Therefore, the vehicle agent 101, which is an agent that substitutes for a vehicle, is in a position of advancing and coordinating the study with the agent of the user connected to the cyber-vehicle room, which is a position different from the agent of the user. Therefore, in the present embodiment, in a case where it is assumed that such private information or sensitive information is handled, the vehicle agent 101 individually exchanges information with the agent without sharing the entire information.

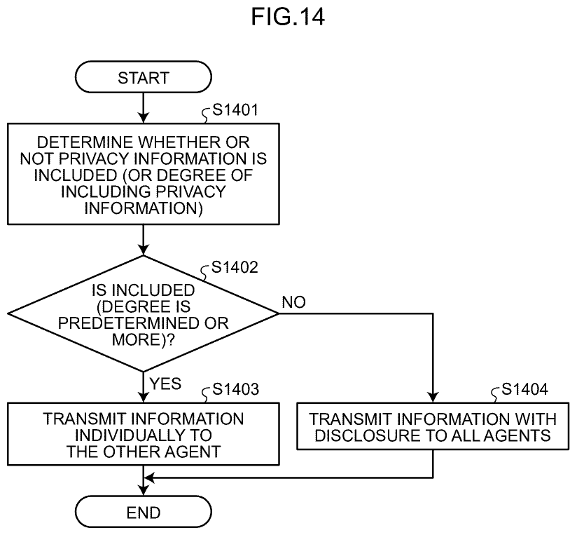

FIG. 14 is a flowchart illustrating an example of a procedure of processing of switching transmission destinations in accordance with properties of information when an agent transmits information in the human-agent interaction system according to the present embodiment.

The procedure of this processing is applied to a case where a certain agent transmits some information to another agent connected to the cyber-vehicle room (that is, an online place where information can be exchanged between agents). Therefore, the procedure is applied to the vehicle agent 101, the agent A 103, and the agent B 106.

The agent transmitting the information determines whether or not the information to be transmitted includes privacy information or sensitive information about an entity that the agent itself represents or substitutes, or quantifies a degree of including the information (S1401). The entity that the agent itself represents or substitutes is represented by the in-vehicle system 102 for the vehicle, is substituted by the agent A 103 for the user A 105, and is substituted by the agent B 106 for the user B 108.

The in-vehicle system 102 representing the vehicle may determine, as information sensitive (or privacy information) to the vehicle, information (described in the vehicle data file) related to personal information about an owner of the vehicle, an accident history, and a travel history (where the vehicle has traveled). On the other hand, it may be determined that the vehicle speed, the destination, the route to the destination, the remaining amount of gasoline/battery, and the like of the vehicle are not sensitive information. This is not in the form of applicable/not applicable determination, and may be quantitatively determined individually.

In addition, the agent substituting for the user may determine personal information (name, address, telephone number, date of birth (age), etc.) of the user, information regarding a living body (sex, health condition, medical history, etc.), information regarding a belief (such as religion), and information regarding a creed (strong restrictions on meals, politics, culture, etc.) as privacy information or sensitive information for the user (described in the user data file). On the other hand, it may be determined that the user's preference for the meal genre, the field/matter of high curiosity or interest, the matter already shared with the information provision destination partner, and the like are not privacy information or sensitive information. This is not in the form of applicable/not applicable determination, and may be quantitatively determined individually. This quantitative determination may be made on the basis of the relationship between the user and the other party to which the information is to be provided.

Next, the agent that transmits information determines whether the information to be transmitted includes privacy information or sensitive information, or determines whether a result of quantifying a degree of the privacy information or the sensitive information is a predetermined value or more (S1402).

If this determination is “Yes”, the agent transmitting the information transmits the information only to the agent of the information transmission destination in order to individually handle the information to be transmitted (S1403). In a case where there are more than one agents as information transmission destinations, information may be individually transmitted to each agent. The individual communication can be implemented by an agent that transmits information exchanging information with an agent of an information transmission destination via a communication means shared by the only two parties.

For example, an endpoint (API URL or the like) of the agent may be disclosed, and information may be exchanged by transmitting and receiving a text message or the like to and from the endpoint by using a communication protocol such as an HTTP request. Alternatively, as with a human, information can be exchanged on a chat in which the only two agents participate using a service of the SNS. The individual communication means may be any method as long as the two agents can directly exchange information without sharing information with a third party, and is not limited to a specific communication means or method.

In a case where the determination is “No” in step S1402, since the agent that transmits the information does not need to individually handle the information to be transmitted, the information is transmitted in a form in which all the agents connected to the cyber-vehicle room including the agent of the information transmission destination can view the information (S1404).

In this form, for example, in a case where the cyber-vehicle room is in a form such as an online meeting room, all the participants can acquire/browse the information such as a statement or a text chat in the online meeting room. In a case where the cyber-vehicle room is in the form of a SNS group, all members participating in the group can acquire/browse the information as a conversation log of the group. The present embodiment does not limit the embodiment of information sharing as long as the information can be shared while being shared by an agent that satisfies a predetermined relationship, such as being connected to a cyber-vehicle room.

In this way, if the agent that provides the information determines the property of the information and determines that the information corresponds to the privacy information or the sensitive information, the information is individually transmitted to the other agent, and if the information does not correspond to the privacy information or the sensitive information, the information is transmitted to all the related agents in a form that the information can be browsed. In a case where the information is transmitted while being disclosed, it is useful in terms of transparency, symmetry, simultaneity, and the like of information among all the related agents. Therefore, in a case where there is no reason to individually transmit the information, it is desirable to transmit the information in a form shared with all the agents.

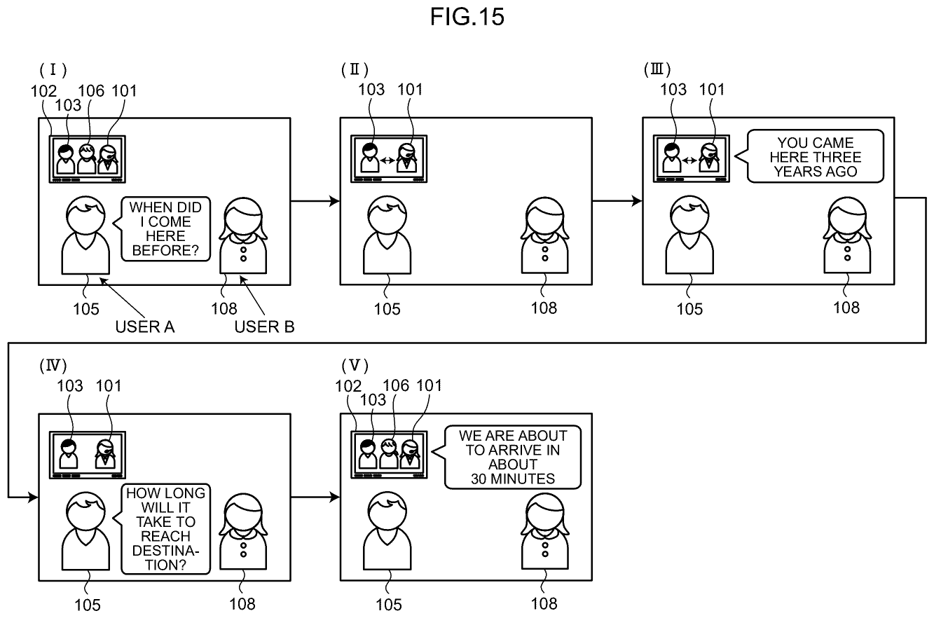

FIG. 15 is a diagram illustrating an example in which a vehicle agent responds to an inquiry about privacy of a user by individually communicating only with an agent of the user in the human-agent interaction system 100 according to the present embodiment.

There may be a case where the user wants to use his/her own agent for privacy communication while moving in the vehicle. In such a case, this figure illustrates a scene where the vehicle agent 101 dynamically switches the connection destination so as to individually interact with the agent of the user. When the exchange is completed, the scene is also a scene in which the interaction with the user is advanced while sharing information with other agents as before.

First, (I) illustrates a state in which the user A 105 and the user B 108 are in the real vehicle interior, and the user A 105 asks the in-vehicle system 102 about the time when the user A 105 arrived at the current location, saying “When did I come here before?”. The UI unit 215 of the in-vehicle system 102 displays an avatar of the vehicle agent 101, an avatar of the agent A 103, and an avatar of the agent B 106, which are all connected to the cyber-vehicle room. For example, in this state, interaction between the vehicle agent 101 and the user A 105 or the user B 108 in the real vehicle interior and interaction between agents connected to the cyber-vehicle room are shared between the agents as text data. An important point is that both the agent A 103 and the agent B 106 access exactly the same information, and there is no asymmetry of information between them.

Next, in (II), the vehicle agent 101 that has received a question from the user A 105 determines that the question relates to privacy information because the question relates to the behavior history of the user A 105. Then, in order to proceed to the processing of step S1403, the question message is individually transmitted only to the agent A 103. In the UI unit 215 of the in-vehicle system 102, a picture or a mark indicating a state in which the vehicle agent 101 individually exchanges information only with the agent A 103 is displayed to the user (user A 105) in the real vehicle interior. Here, as an example, the avatar of the agent B 106 is deleted from the UI unit 215, and arrows in both directions are displayed between the vehicle agent 101 and the agent A 103.

In a case where the avatar of the agent B 106 is not displayed on the UI unit 215, it becomes hard to know whether or not it is connected to the cyber-vehicle room. Therefore, only the agent B 106 may be grayed out and continuously displayed, or additional information indicating that the vehicle agent 101 and the agent A 103 are individually connected may be displayed. For example, additional information as if the vehicle agent 101 and the agent A 103 are talking on a yarn phone may be displayed.

Next, in (III), the vehicle agent 101 acquires an answer from the agent A 103, and replies to the user A 105 that “You came here three years ago”. Since the state in which the vehicle agent 101 and the agent A 103 individually exchange information continues, the connection state of the avatar similar to (II) is displayed on the UI unit 215.

Note that regarding the question about the user A 105′s own behavior history, the user B 108 in the same real vehicle interior hears the question, and the user B 108 also hears the answer of the vehicle agent 101 to that question. That is, it can be said that privacy information indicating that the user A 105 came near the current location three years ago is leaked to the user B 108. However, it can be considered that the fact that the user A 105 asked the question under the situation where the user B 108 is in the same real vehicle interior means that it is not a concern or sufficiently low for the user A 105 that the answer is transmitted to the user B 108.

Rather, serious information leakage for the user A 105, the service provider of the agent A 103, or the service provider of the vehicle agent 101 is not for the user B 108, but for the agent B 106 that the user B 108 uses. Since the agent B 106 is software capable of autonomously acting, if there is maliciousness or due to malfunction even if there is no maliciousness, the reputation or credibility of the user A 105 or the service provider of the agent A 103 or the vehicle agent 101 may be damaged in the cyberspace. In addition, there may be a concern that information once known to the agent B 106 may train the agent B 106 or recorded in a training database.

For example, as an example, it is conceivable that the agent B 106 uses the SNS account of the user B 108 to share the obtained information widely to an unspecified number of people. In such a case, there is also a risk of remaining in the network as information that cannot be erased.

In order to solve the above new problem, the present embodiment proposes a mechanism for switching information distribution between agents in accordance with the property/content of the information. In addition, it is proposed that the state of information distribution is visualized in an easy-to-understand manner and presented to the user.

Next, in (IV), the user A 105 asks a question about the traffic condition “How long will it take to reach the destination?” that is not related to anyone's privacy information. The in-vehicle system 102 recognizes this question of the user A 105 and transfers it to the vehicle agent 101.

Next, in (V), the vehicle agent 101 that has received the question acquires the real-time traffic condition from the third party service via the network 109, and replies “We are about to arrive in about 30 minutes” as the estimated time of arrival at the destination.

The vehicle agent 101 determines that the exchange regarding the estimated time of arrival at the destination does not include privacy information or sensitive information about anyone, and the processing of step S1404 is performed. Therefore, this exchange is shared among all the agents connected to the cyber-vehicle room, and the avatar of the agent B 106 is displayed on the UI unit 215 to indicate the exchange being shared.

In the present embodiment, the vehicle agent 101 mediates information distribution between the user in the real vehicle interior and the agent in the cyber-vehicle room. Therefore, the agent in the cyber-vehicle room (that is, the agent of each user) cannot detect the situation of the real vehicle interior and the state of the vehicle. That is, the agent of the user cannot know the interaction between the users in the real vehicle interior and the current vehicle state (for example, the vehicle speed, the remaining amount of fuel, and the like) unless they are shared in the cyber-vehicle room.

In the human-agent interaction system 100, the vehicle agent 101 mediates/controls information distribution between the real vehicle interior and the cyber-vehicle room as described above. Therefore, the risk of leakage of the privacy information to the agent can be eliminated. If the in-vehicle system 102 or the vehicle agent 101 shares the interaction in the real vehicle interior with the agents connected to the cyber-vehicle room without any restriction, there is a risk that all the conversations in the real vehicle interior including the privacy information about the user is used for training unrelated agents of a third party or stored by them and are used in a form not intended by the user. In order to prevent such an unexpected situation from occurring, it is significant to cause the vehicle agent 101 to control information distribution/sharing between the real vehicle interior and the cyber-vehicle room.

There are two types of agents connected to the cyber-vehicle room: the vehicle agent 101 and an agent that acts as a substitute for the user, but only the vehicle agent 101 has a contact with the real vehicle interior and the real world of the vehicle. The agent of the user contacts digital data shared in the cyber-vehicle room, but the information regarding the real vehicle interior and the vehicle is only information transmitted via the vehicle agent 101. In other words, by setting asymmetry of information between the vehicle agent 101 and the agent of the user as a basic design of the human-agent interaction system 100, it is possible to protect the privacy information and the sensitive information about the user from the agents of other users while using the human-agent interaction system 100.

Note that, in the above description, when handling privacy information and sensitive information, related agents individually communicate with each other, and the state is visualized. However, even if another agent can receive the exchange, it is considered that this concern can be reduced as long as information regarding the exchange is not trained or recorded as digital data (including writing on the net, transmission to another agent, and the like). Therefore, a mode indicating that the information received by the agent is not trained or recorded at all may be provided, and that the agent is operating in the mode may be visually or aurally expressed to the user. For example, the fact that the avatar of the agent wears sunglasses or does not have an information terminal such as a personal computer or a smartphone may mean that the agent is operating in a mode of not training or recording at all.

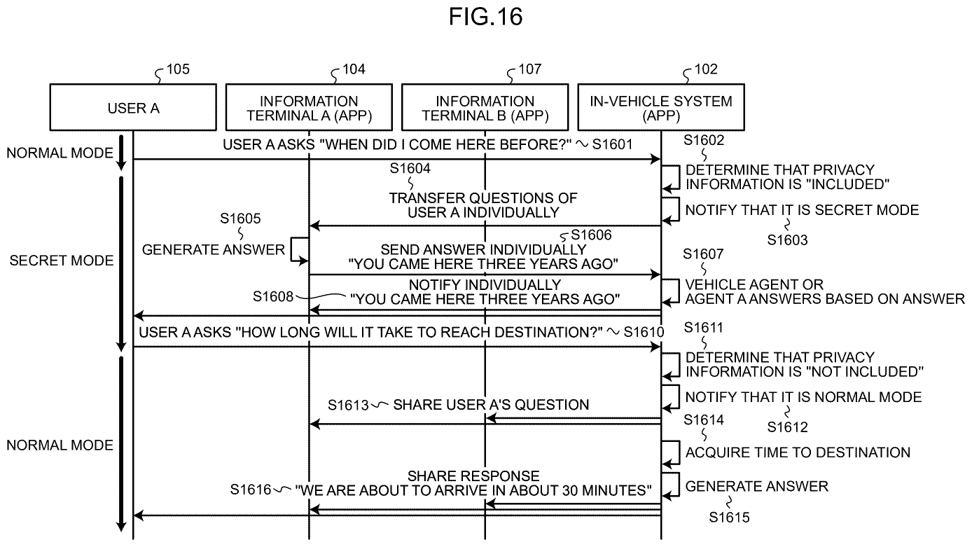

FIG. 16 is a sequence diagram illustrating an example of a procedure in which the vehicle agent 101 responds to an inquiry regarding privacy of a user by individually communicating only with an agent of the user in the human-agent interaction system 100 according to the present embodiment.

When the agent on the information transmission side (such as the vehicle agent 101) determines that the exchange of information includes (or a degree of including is equal to or greater than a predetermined value) privacy information or sensitive information about someone, the exchange of the information is performed by individual communication only for related persons is referred to as a “secret mode”. On the other hand, a state in which, when the agent on the information transmission side (such as the vehicle agent 101) determines that the exchange of information does not include (or a degree of including is less than a predetermined value) privacy information or sensitive information about anyone, the exchange of the information is performed by communication shared for all the related persons is referred to as a “normal mode”.

That is, the operation mode of the human-agent interaction system 100 (or the individual agent) is switched such that communication is performed in the secret mode in a case where the determination is Yes in step S1402 in FIG. 14, and communication is performed in the normal mode in a case where the determination is No.

Since the scene here is the scene of FIG. 15, redundant description may be omitted.

First, the user A 105 asks the in-vehicle system 102 about when the user A 105 come to this place before (S1601). In response to this, the in-vehicle system 102 notifies the vehicle agent 101 of (the result of voice recognition of) this question.

The vehicle agent 101 determines that the question (or a series of exchanges including an answer to the question) includes privacy information or the possibility of including privacy information is more than a predetermined amount (S1602). Then, this exchange is shifted to a secret mode in which information is exchanged individually with the user A 105 and the agent A 103.

The user A 105 is also notified of the operation in the secret mode via the UI unit 215 (S1603). For example, the avatar of the agent B 106, which is not a target of information exchange in the secret mode, may be grayed out or made to wear ear plugs, only a target person (in this case, the vehicle agent 101 and the agent A 103) in the secret mode may be highlighted, connection may be made with a yarn phone, or a state in which secret conversation is being held apart from another agent may be expressed. Alternatively, when the vehicle agent 101 responds to the user, explanation may be made regarding the operation in the secret mode, switching may be made to voice for the secret mode or sneak speaking, an answer may be displayed on a monitor that can be seen only by related persons when the UI unit 215 displays the answer, or a display method (deflection filter or the like) of the screen may be controlled so as to be seen only from the direction of the queried user A 105.

The vehicle agent 101 operating in the secret mode individually transfers a message (question content of the user A 105) including privacy information about the user A 105 or having a high degree of including privacy information about the user A 105 only to the agent A 103 of the related user A 105 (S1604).

Receiving this, the agent A 103 refers to the behavior history information about the user A 105 and generates an answer message indicating that the user A 105 has come to the place three years ago (S1605). Here, it is assumed that a right to access privacy information about the user A 105 including the behavior history information is given to the agent A 103 in advance (the setting is made).

Then, the agent A 103 returns the answer message “You came here three years ago” only to the vehicle agent 101 that has individually sent the question (S1606). Based on this answer, the avatar of the vehicle agent 101 or the agent A 103 answers (individually) to the user A 105 via the UI unit 215 (S1607). As a result, an answer message “You came here three years ago” is notified to the user A 105 in the real vehicle interior as video or audio information (S1608), and the agent A 103 connected to the cyber-vehicle room is also individually notified of the answer to the user A 105 in such a manner.

Steps S1602 to S1608 are an example in which the operation is undergoing in the secret mode. This is because the human-agent interaction system 100 determines to handle privacy information.

Next, the user A 105 newly asks a question “How long will it take to reach the destination?” to the in-vehicle system 102 (S1610). The vehicle agent 101 that has received the question performs the determination in step S1402, and determines that the privacy information and the sensitive information about anyone are not included or the degree thereof is less than the predetermined value (S1611).

The information such as the travel time and the travel distance required to reach the destination is a topic common to the users in the real vehicle interior and depends on the traffic condition to the destination and the like, but is a topic unrelated to privacy information or sensitive information about the vehicle or an individual user. Therefore, the vehicle agent 101 determines the change from the secret mode to the normal mode, switches the operation mode of the human-agent interaction system 100 to the normal mode, and notifies the user of the switching via the UI unit 215 (S1612).

The notification that the human-agent interaction system 100 is operating in the normal mode is opposite to the indication that it is operating in the secret mode described above. Information distribution between the real vehicle interior and the agent connected to the cyber-vehicle room is shared by all the participants. Therefore, in the UI unit 215, as illustrated in FIG. 15 (V), the avatars of the agents connected to the cyber-vehicle room are all displayed, indicating that all the agents share the information. Note that, in a case where there is a problem that the display indicating the normal mode narrows the display area of the UI unit 215, the normal mode may be indicated by an icon, or identification information (icons indicating the secret mode and agents interacting in the secret mode) may be displayed only in the secret mode.

Since the mode is switched to the normal mode, the vehicle agent 101 shares the question content of the user A 105 with all the agents connected to the cyber-vehicle room (S1613). Further, estimated time information to the destination is acquired (from a navigation system of the in-vehicle system 102 through API cooperation or the like, or in cooperation with an external service via the network 109) (S1614). Then, the vehicle agent 101 generates an answer message “We are about to arrive in about 30 minutes” on the basis of the obtained information (S1615). Subsequently, since the mode is the normal mode, the generated answer message is sent to all the agents connected to the cyber-vehicle room and the user A 105 who has asked the question (S1616).

As described above, in a case where the human-agent interaction system 100 detects that exchanges privacy information or sensitive information related to the user or the vehicle occurs by the user, the information distribution is switched to the secret mode, and the information is exchanged between the minimum necessary agents. In a case where it is detected that the information is not such information, the information distribution is switched to the normal mode, and information about exchange is shared with all the agents connected to the cyber-vehicle room. By switching in accordance with the information handling how information is distributed, it is possible to prevent information from being shared/leaked to the agent of another person (third party) connected to the cyber-vehicle room. As described above, a mechanism for preventing unnecessary information sharing and information leakage with respect to an agent capable of spontaneously acting in the cyberspace is expected to be highly demanded in the future world where the agents become widespread.

Note that the present disclosure is not limited to the embodiment in which switching is performed on the basis of the information handling how information is distributed as described above. Hereinafter, a method for not switching the operation mode will be described.

In the above description, the description has been given on the assumption that the human-agent interaction system 100 operates in the normal mode, or an operation is performed by individual communication between related agents as a secret mode according to information handled. As another embodiment, all the agents of the user connected to the vehicle agent 101 may individually communicate with the vehicle agent 101 regardless of the information to be handled.

In FIGS. 3 to 7, it has been described that the agent of the user is connected to the other agents via the network 109 including the vehicle agent 101 by acquiring the access information about the online meeting room in which a plurality of users can enter and exit from the room and the account information/group information about the SNS. These are examples of a method of performing information sharing with a plurality of agents in the cyberspace. However, instead of the access information about the online meeting room and the account information about the SNS, an endpoint (such as a URL for directly exchanging information with the agent via the API) of the agent to be connected may be acquired.

For example, the user A 105 may read the QR code storing the endpoint of the vehicle agent 101 displayed on the UI unit 215 of the in-vehicle system 102 using an application (camera or agent A 103) operated on the information terminal A 104.

The agent A 103 may transmit its own endpoint (access information) to the acquired endpoint of the vehicle agent 101 so that the vehicle agent 101 can transmit a message to the agent A 103.

Moreover, the agent A 103 may transmit and receive a text of a message to be exchanged to and from the endpoint of the vehicle agent 101 via a communication protocol such as an HTTP request (POST, GET, etc.), WebSocket, or gRPC.

For secure communication, connection authentication may be performed using an API key or a token at the start of connection. As a result, it is possible to confirm that the agents are appropriately recognized and exchange of messages is permitted.

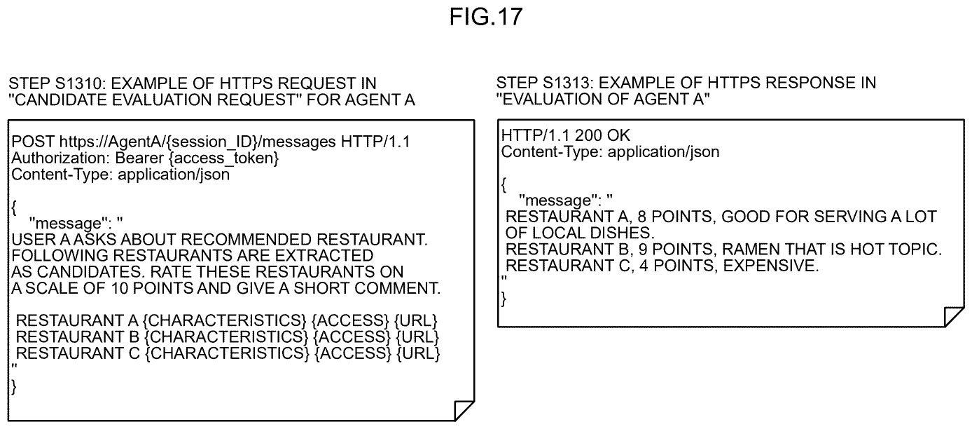

FIG. 17 is a diagram illustrating an example in which the vehicle agent 101 uses an API (HTTP request/response) when individually communicating with the agent A 103 of the user A 105 in the human-agent interaction system 100 according to the present embodiment. In particular, here, a specific example of exchange in step S1310 and step S1313 in FIG. 13 will be described.

In step S1310, the vehicle agent 101 transmits a request message for evaluating a restaurant candidate to the agent A 103. Although the connection establishment processing between the vehicle agent 101 and the agent A 103 will not be described, if the two parties are connected by the HTTP protocol, the HTTPS request as described in the example (left side) of the HTTPS request of FIG. 17 may be transmitted from the vehicle agent 101 to the agent A 103.

The first line indicates that this request is transmitted to an endpoint (access destination URL) of the agent A 103 of https://AgentA/{session_ID}/messages by the POST method of version 1.1 of HTTP. A unique session ID of this communication session is described in “{session_ID}”.

In the second line, an access token used for authentication with the server on which the agent A 103 operates is specified by {access_token} in the Authorization header. The access token is a secret authentication code issued to secure this connection, and is used for determining that the server approves the request.

The third line is a Content-Type header and specifies that a data format to be transmitted is JSON. In the subsequent request body, the content of the message to be transmitted is described in a JSON format. Text data for requesting the agent A 103 to evaluate a restaurant candidate is described as a message. Specifically, the part “@agent A, @agent B” meaning the mention is deleted from the content described in FIG. 11. This is because this is an individual HTTPS request to be transmitted from the vehicle agent 101 to the agent A 103, and thus, it does not need the mention to specify the other party.

In step S1313, the agent A 103 transmits an answer message evaluated for the restaurant candidate to the vehicle agent 101. If the two parties are connected by the HTTP protocol, the HTTPS response as described in the example (right side) of the HTTPS response of FIG. 17 may be transmitted from the agent A 103 to the vehicle agent 101.

The first line indicates that the request is normally processed by returning a status code “200 OK” as a response.

The second line is a Content-Type header for specifying that a data format to be transmitted is JSON.

In the subsequent response bodies, messages to be responded to by the server of the agent A 103 are described in a JSON format. Here, as a message, an evaluation and a short comment on the restaurant candidate of the agent A 103 are described as text data.

As described above, the two agents may directly connect to each other via a predetermined communication protocol using the end point to transmit and receive a message. In this case, even if another agent is connected to the cyber-vehicle room, the exchange between the vehicle agent and each agent is individual communication and is not shared with another agent. Therefore, it is possible to eliminate the risk of information leakage and unauthorized use for the agent described above.

Note that the cyber-vehicle room of the human-agent interaction system 100 may be connected only by individual communication between two agents in this manner. In that case, since the agents of the users who get on together do not directly share information, it is considered that the human-agent interaction system 100 having high psychological safety can be implemented in a case where an unspecified number of users get on the same vehicle (real vehicle interior).

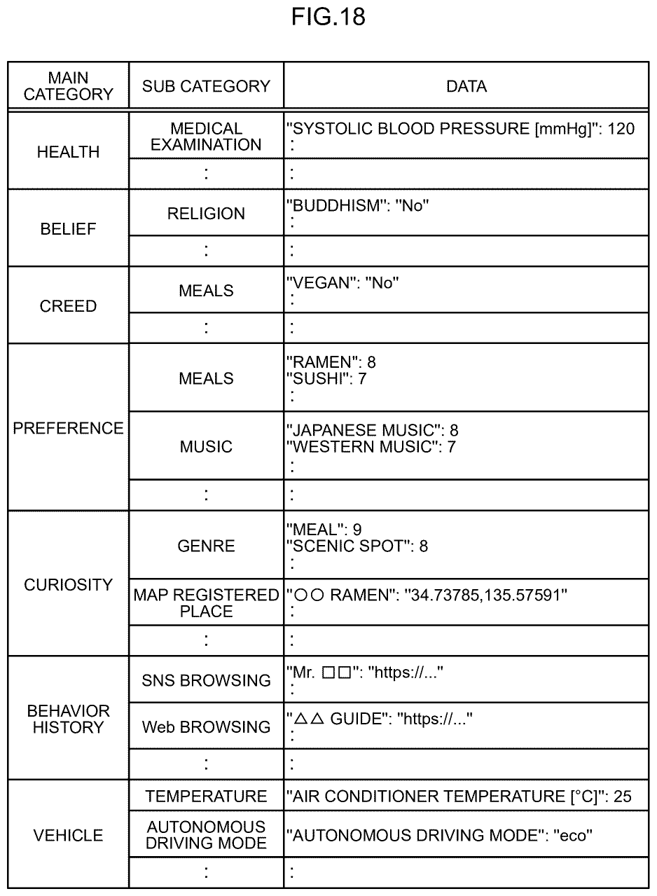

FIG. 18 is a diagram illustrating an example of user data referred to by an agent of a user in the human-agent interaction system according to the present embodiment. As described above, the agent used by the user connects to the cyber-vehicle room and transmits information while referring to the health, belief, creed, preference, curiosity, behavior history, vehicle interior environment, and the like of the user, and this drawing illustrates an example of data referred to at that time.

As illustrated here, the user data is described separately from the main category, the sub category, and the data. As a result, the agent can generate an answer personalized to the user while referring to this data regarding the degree of curiosity of the user and the like. In addition, it is assumed that a setting in which the agent can access the user data is made in advance.

Note that the user data is securely managed in the memory of the computer system in which the agent operates. For example, when (the program of) the agent A 103 operates on the information terminal A 104, the user data file securely managed in the memory 204 of the information terminal A 104 is referred to.

On the other hand, in a case where (the program of) the vehicle agent 101 operates on the in-vehicle system 102, the vehicle data file securely managed in the memory 214 of the in-vehicle system 102 is referred to. In the vehicle data file, personal information about the owner of the vehicle, an accident history, and a travel history (where the vehicle has traveled) may be described.

In the main category of health, a medical examination or the like is classified as a sub category. The user's medical examination result is described in the data for the medical examination. For example, it is described that the systolic blood pressure is 120 mmHg. This information is used, for example, for recommendations regarding meals and exercise.

Religions and the like are classified as sub categories in the main category of the belief. Religions believed by the user with respect to the religions are described in the data. For example, it is described that the user does not believe in Buddhism. This information is used, for example, for recommendations regarding meals, sightseeing spots, and shopping.

Meals and the like are classified as sub categories in the main category of creed. The user's creed in the diet is described in the data. For example, it is described that the user is not a vegan. This information is used, for example, for recommendations regarding meals and shopping.

Meals and the like are classified as sub categories in the main category of preferences. The user's preference in the meals is described in the data. For example, the degree of preference for each dish, such as 8 for ramen and 7 for sushi, is quantified and described. This information is used, for example, for recommendations regarding meals. In addition, in the sub category of music, the preference of the user for music is described in the data. For example, the degree of preference for each music genre such as 8 for Japanese music and 7 for Western music is quantified and described. This information is used, for example, for recommendation regarding music to be reproduced by the in-vehicle system 102.

Genres and the like are classified as sub categories in the main category of curiosity. The degree of curiosity of the user is quantified and described with respect to the genre. For example, the degree of curiosity for each genre such as 9 for a meal and 8 for a scenic spot is quantified and described. This information is used, for example, for recommendation regarding a nearby place to stop by. In addition, in the sub category of the map registered place, a point registered by the user in the map service is described in the data. For example, place information such as latitude and longitude indicating the place of ramen [symbol] is described. This information is used, for example, for recommendation regarding a nearby place to stop by.

SNS browsing or the like is classified as sub categories in the main category of the behavior history. A browsing history of the user for SNS browsing is described in the data. For example, it is described that the user has browsed content of https:// . . . posted on the SNS by Mr. □□. This information is used, for example, for recommendation regarding a place to stop by. Similarly, a browsing history of the user for web browsing is described in the data. For example, it is described that the user has browsed contents of a web page (https:// . . . ) called [symbol] guide. This information is used, for example, for recommendations regarding sightseeing spots, restaurants, shopping, content to be reproduced, routes, and places to stop by.

In the main category of the vehicle, temperature or the like is classified as sub categories. The user's recommended setting for temperature is described in the data. For example, 25° C. as the air conditioner temperature or the like is described. This information is used, for example, for recommendation regarding control of the vehicle interior environment. Further, the user's recommended setting for the autonomous driving mode is described in the data. For example, it is described that an eco-driving mode having a low environmental load is recommended as the autonomous driving mode. This information is used, for example, for recommendation regarding control of vehicle driving.

As described above, with reference to the information in these user data files, the agent can generate, evaluate, or request another agent (for example, the vehicle agent 101) to give a recommendation degree regarding a sightseeing spot, a restaurant, a route to a waypoint/destination, video/audio content to be reproduced, lighting of a vehicle interior or a seat, a temperature, an autonomous driving mode, and the like recommended to the corresponding user.

Note that, in the above description, the vehicle agent 101 and agents (agent A 103 and agent B 106) of one or more users are connected via the network 109, and a wide variety of options are searched, evaluated, recommended, or selected. However, such study may be performed by calling another agent, particularly a specialized agent having detailed knowledge in a specific field, and performing joint study.

Specifically, a regional tourism specialized agent that introduces tourism of a region including the current position of the vehicle may be connected (by the vehicle agent 101) to the cyber-vehicle room via the network 109 to recommend a recommended visit place, or characteristics of a recommended candidate may be introduced. The vehicle agent 101 may select the regional tourism specialized agent in accordance with the current location of the vehicle and cause the selected agent to participate in the cyber-vehicle room. It is considered that the possibility of extracting, evaluating, or recommending an experience candidate such as sightseeing, meals, or shopping unique to the region on the basis of local-based information is increased by adding such a regional tourism specialized agent as an evaluator, and the user's travel experience can be improved.

In another use case, a regional traffic monitoring specialized agent that is familiar with the traffic condition near the current location of the vehicle may be similarly connected to the cyber-vehicle room, and the route selection may be studied together.

The vehicle agent 101 can widen the range of discussion between the agents and increase the depth by connecting one or more such external specialized agents in accordance with the study themes or appropriately releasing the connection. Of course, as a result, the human-agent interaction system 100 can not only improve the movement experience of the user, but also reduce the environmental load and reduce the traffic congestion due to inefficient travel route selection.

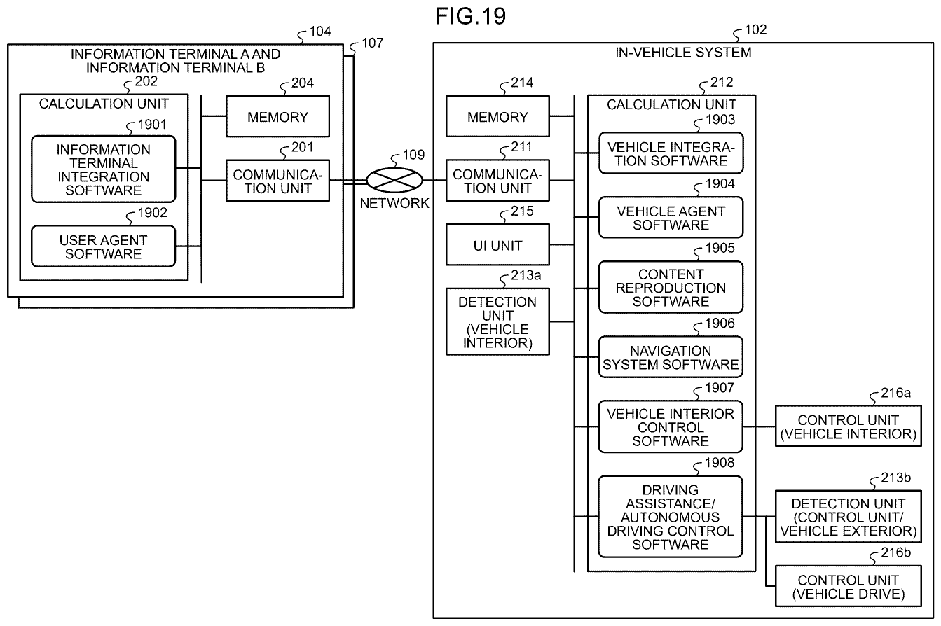

FIG. 19 is a diagram illustrating an example of cooperation between a software configuration and a hardware configuration of the human-agent interaction system 100 according to the present embodiment. Here, the reference numerals used in FIG. 2 are used as much as possible. Except for newly assigned reference numerals, the detection unit 213 of the in-vehicle system 102 is described separately as a detection unit (vehicle interior) 213a for detecting states of a user, a seat belt, a seat, and the like in the vehicle interior, and a detection unit (control unit/vehicle exterior) 213b for detecting a control unit for controlling a power train (here, it refers to a set of drive parts of a vehicle including generating and transmitting a drive force of the vehicle and rotating a tire) of the vehicle and an external situation around the vehicle.

In addition, the control unit 216 is described separately as a control unit (vehicle interior) 216a for controlling and driving devices (seats, lighting, an air conditioner, etc.) in the vehicle interior, and a control unit (vehicle drive) 216b that includes a physical mechanism that drives (travel and stop) the vehicle including a power train and a driving device of the vehicle and that controls the physical mechanism. The control unit (vehicle drive) 216b includes a mechanism that physically implements in accordance with an autonomous driving function of automatically operating a driving device (steering wheel, accelerator, brake, and the like) of the vehicle on the basis of a driving assistance function (auxiliary driving function such as stopping by an obstacle or traveling while maintaining a lane) of the vehicle and an instruction of autonomous driving control software for automatically traveling to a destination registered in a navigation system, and a control function thereof.

The blocks to which the reference numeral are newly assigned are the software operating in the calculation unit. The software executed by the calculation unit 202 of the information terminal or executed in conjunction with another computer system via the network 109 includes information terminal integration software 1901 that integrates the entire function of the information terminal, and user agent software 1902 that performs training and inference processing of the agent of the user, operation control and utterance control of the avatar representing the body and appearance of the agent, and the like.

The software executed by the calculation unit 212 of the in-vehicle system 102 or executed in conjunction with another computer system via the network 109 includes: vehicle integration software 1903 that integrates the entire function of the in-vehicle system 102; vehicle agent software 1904 that performs training and inference processing of an agent of the vehicle, operation control, and utterance control, and the like of an avatar of the vehicle agent; content reproduction software 1905 that controls reproduction of video content, music content, and the like via the UI unit 215; navigation system software 1906 that performs search, setting, update, and the like of a route to a destination or a waypoint of the vehicle; vehicle interior control software 1907 that controls devices (seats, lighting, air conditioner, etc.) in the vehicle interior; and driving assistance/autonomous driving control software 1908 that supports safe traveling of the vehicle in accordance with sensor data of the detection unit 213b of the vehicle and the destination/route registered in the navigation system software 1906 and instructs the control unit 216b to perform a driving operation for autonomous driving.

### Operation Processing

Hereinafter, details of the operation processing of the embodiment described with reference to FIG. 2B will be described.

An example of the hardware and software by which the processing of steps S808 to S810 of FIG. 8 (or steps S1020 to S1022 of FIG. 12) is performed will be described in detail with reference to FIG. 19.

The response (utterance) of user B 108 “I'll go there” is acquired through the voice microphone of detection unit 213a, the camera for the vehicle interior (for example, speech recognition by lip reading and intention estimation by gesture), and the like. The vehicle integration software 1903 (or the vehicle agent software 1904) performs voice recognition or image recognition processing on the basis of the sensing data, and recognizes that the user B 108 has uttered “I'll go there”.

The user's utterance in the vehicle interior (corresponding to one line of the chat content of FIG. 11) may be notified from the vehicle integration software 1903 to the vehicle agent software 1904 via a predetermined API, or the vehicle agent software 1904 may perform voice recognition processing or the like and recognize the utterance.

The vehicle agent software 1904 that has recognized the determination intention of the user for the recommended candidate by the natural language processing from the result of the voice recognition transmits a request for setting or change processing related to the determined candidate to software that controls and manages the corresponding function. Note that the software for controlling the function includes software for controlling vehicle equipment and components provided in the vehicle. Although there are multiple patterns, two representative processing request patterns will be described.

### 1. Pattern for Requesting Change to Navigation System

In a case where, when the study theme in the human-agent interaction system 100 is a sightseeing spot, a restaurant, or a sales store (shopping) that the user wants to stop by and it is determined to stop by these places, it is necessary to change to a route including the specific places. Therefore, the vehicle agent software 1904 requests the navigation system software 1906 to change the route to the new waypoint/destination.

When receiving this request via a predetermined API, the navigation system software 1906 searches for a new travel route on the basis of the current location and the new waypoint/destination. Here, in order to simplify the description, it is assumed that the candidates of the route are narrowed down to one. In a case where there are more than one route candidates, the route candidates may be displayed on the UI unit 215 to be selected by the user. In addition, in order to enable the user to make a determination based on the traffic condition for each route candidate, the travel time, the travel distance, the travel fee, and the like may be displayed.

When the route is determined, the navigation system software 1906 notifies the driving assistance/autonomous driving control software 1908 of the route information via a predetermined API. Alternatively, the driving assistance/autonomous driving control software 1908 may check and acquire the current set route information on the basis of the time of occurrence of a specific event (when a route change event occurs, when a traffic condition changes, etc.) or condition matching (when a predetermined time has elapsed, when the vehicle is started, etc.) with respect to the navigation system software 1906 (or the vehicle integration software 1903 or the like).

In response to this, the driving assistance/autonomous driving control software 1908 instructs the control unit 216b to assist safe traveling of this vehicle and perform a driving operation for autonomous driving in cooperation with the detection unit 213b in accordance with the newly registered destination/route. Accordingly, the control of the powertrain and the driving device in the control unit 216b is physically executed and controlled so as to travel along the newly registered route, and it is possible to safely and/or automatically move the user in the real vehicle interior to a sightseeing spot or a restaurant that the user wants to stop by and is determined by the human-agent interaction system 100.

Note that although the vehicle agent software 1904 has been described as transmitting the route change request to the navigation system software 1906, the route change request may be transmitted to another software (for example, the vehicle integration software 1903, the driving assistance/autonomous driving control software 1908, and the like.).

In a case where a robot taxi is used as a means of transportation at a travel destination with a friend and the human-agent interaction system 100 is installed, an agent tells about local specialties, the agent proposes a sightseeing spot, a restaurant, or shopping in accordance with the curiosity of all parties, or transportation to a place of curiosity is autonomous driving. Therefore, once the destination is determined, all parties can move to the place automatically, thereby realizing a travel experience different from the previous travel experience. That is, since there is no need to act as a driver, no need to act as a guide, and no need to find a spot to stop by in the vicinity, it is expected to be a travel in which all people can equally enjoy and discover and experience the charm unique to the area.

### 2. Pattern for Requesting Change to Content Reproduction

As another representative processing request pattern, to change a pattern in which content to be reproduced using (the display or the speaker of) the UI unit 215 will be described.

In a case where, when the study theme in the human-agent interaction system 100 is video content such as a movie or a drama to be watched or audio content such as music or a radio to be listened to and it is determined to reproduce certain content, the vehicle agent software 1904 requests the content reproduction software 1905 to reproduce the determined content in accordance with the determination.

The reproduction request may include one or more of a name, an outline, and a reproduction time of the content, a thumbnail image indicating the content, a distribution service name, an acquisition destination URL of the content, a performer/artist name, and an identification code of the content, which are used in the presentation of the recommended candidate in the human-agent interaction system 100.

When this request is received via a predetermined API, the content reproduction software 1905 acquires data of the content via the communication unit 211 on the basis of the content information to be reproduced, decodes the data, and reproduces the data using the display or the speaker of the UI unit 215. As a result, the user can quickly and smoothly watch and listen to the content determined by the human-agent interaction system 100 in the vehicle interior without searching for the content by operating the menu screen or the like by oneself.

As described above, by controlling the hardware of the vehicle in cooperation with the software on the in-vehicle system 102 in accordance with the determination matter determined by the human-agent interaction system 100, it is possible to implement, for example, watching and listening to video content that everyone wants to see in a real vehicle interior, playing a favorite background music, automatically setting a route to a newly determined destination, or automatically driving and taking the user to the destination in the case of an autonomous driving vehicle.

### Availability for Non-Vehicle

Note that, in the various embodiments described above, the human-agent interaction system that interacts with a user who gets in a vehicle and moves has been described as an example, but information processing that interacts with a user in a room and sets and controls hardware related to the room is not limited to the present disclosure.

For example, the vehicle interior as an example of the present embodiment can be regarded as a house as another example.

In the human-agent interaction system 100 illustrated in FIG. 2, if the in-vehicle system 102 is replaced with a home control system that manages residential facilities and home appliances with the same configuration, it is possible to implement an human-agent interaction system in which the home control system executes tasks such as investigation, analysis, evaluation, study, and proposal using an agent of one or more users in a residence in response to a request from the users. For example, the following is conceivable as a use case of the human-agent interaction system 100 for a user in a house.

Fitness proposal: If exercise is insufficient, an exercise that can be performed at home is proposed on the basis of health data and behavior history of a user in a house. There are provided stretching, yoga, a simple muscle training program, and the like, each corresponding to physical conditions and health targets of individual users.

Meal proposal: Recipes are proposed with taking into consideration of the health and taste, dietary restrictions (religious and nutritional) of the user in the house, and nearby healthy restaurants and delivery. For example, a low-calorie meal or a vegetarian menu is proposed.

Air-conditioning management proposal: Appropriate air-conditioning setting and use of a humidifier are proposed based on health data of a user in a house and a current residential environment (humidity, temperature, etc.). A user having an allergy is recommended to turn on/off the air purifier.

Religious event proposal: Based on the belief of user in the house, the time of praying and the religious event are notified to assist preparation. Securing a quiet space in a house and adjusting lighting and volume are automated.

Contents proposal: Video/audio contents are proposed, which all users in a living room of a house can enjoy, and support a time shared by family members. The contents are recommended in consideration of the preference of each user and in a balanced manner that all the users can enjoy.

Monitoring proposal: In a case where an abnormality is observed in a health condition (for example, a heart rate or a body temperature) of a user in a house, an alert is automatically transmitted to a nearby hospital or a family, and a necessary support is proposed.

In the human-agent interaction system 100 described above, it is possible to support a richer, more comfortable, and more convenient life in the residence for the study theme such as the use case described above by simply replacing the in-vehicle system 102 with the home control system, the cyber-vehicle room with the cyber house, and the vehicle agent 101 with the residence agent. Therefore, the human-agent interaction system 100 is considered to be very useful not only for the user who moves in the vehicle but also for the user who stays in the house.

Note that the human-agent interaction system 100 of the present disclosure is not limited to a vehicle or a house. In a space where one or more users are present, if an agent evaluates an event having a large number of options that all users in the space commonly experience and proposes the event to the user, the system can be used. For example, the space control (lighting, air conditioning, audio, display content, and the like) of a shop, a restaurant, an office, a public transportation vehicle, a station or an airport yard, a large building, a shopping mall, a school, a cram school, a library, or the like may be suggested or automatically changed on the basis of the evaluation of the agent of the user who is present at the place.

Note that a computer program executed by each of devices in the human-agent interaction system 100 according to each of the above-described embodiments can be provided by being recorded in a computer-readable recording medium (Computer Program Product) such as a CD-ROM, a FD, a CD-R, or a DVD as a file in an installable format or an executable format.

The program executed by each of devices in the human-agent interaction system 100 according to each of the above-described embodiments may be stored in a computer connected to a network such as the Internet and provided by being downloaded via the network. In addition, the program executed by each of devices in the human-agent interaction system 100 according to the above-described embodiments may be provided or distributed via a network such as the Internet.

In addition, the program executed by each of the devices in the human-agent interaction system 100 according to each of the above-described embodiments may be provided by being incorporated in advance in ROM or the like.

According to at least one embodiment described above, it is possible to realize further improvement by using the agent capable of interaction associated with the user.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing method of an Artificial Intelligence (AI) agent executed by a computer included in a system incidental to a room, the AI agent including a room AI agent and one or more personal AI agents, the room AI agent serving to receive and respond to an instruction from a user in the room via a voice interaction interface (VUI), the one or more personal AI agents corresponding to one or more users in the room, the information processing method comprising:
connecting the one or more personal AI agents and the room AI agent to a virtual space where interaction between the one or more personal AI agents and the room AI agent is enabled;
in a case where a proposal request regarding a topic is made by one or more users in the room, recognizing, by the room AI agent connected to the virtual space, the topic and the one or more users who have made the proposal request via the voice interaction interface (VUI) and notifying the one or more personal AI agents connected to the virtual space of a result of the recognition;
generating, by the one or more personal AI agents connected to the virtual space, one or more proposals based on the recognized topic and a profile of the recognized user; and,
in a case where a proposal is adopted by the user from among the generated one or more proposals, causing the computer to apply, for a system incidental to the room, setting or processing corresponding to the adopted proposal.

2. The information processing method according to claim 1, wherein
the one or more proposals include a destination,
the system incidental to the room includes hardware serving to present information in the room, and
the setting or the processing causes the hardware of the system incidental to the room to present guide information and/or access information for a destination of the adopted proposal.

3. The information processing method according to claim 1, wherein
the one or more proposals include a destination,
the room is a vehicle interior of a vehicle, and
the setting or the processing sets the destination in a navigation system of the vehicle and/or sets the destination in an autonomous driving control system of the vehicle.

4. The information processing method according to claim 1, wherein
the one or more proposals include a destination, and
the information processing method further comprises, by the one or more personal AI agents connected to the virtual space,
generating an evaluation of the destination based on the profile of the recognized user, and
attaching the evaluation to the one or more proposals.

5. The information processing method according to claim 1, wherein
the one or more proposals include a destination, and
the information processing method further comprises, by the one or more personal AI agents connected to the virtual space,
accessing local information and map information about a region to which the destination belongs,
determining effectiveness of the destination based on the local information and the map information, and
generating the one or more proposals based on a determination result of the effectiveness.

6. The information processing method according to claim 1, wherein
the room is a vehicle interior of a vehicle,
the virtual space is a cyber-vehicle room, and
the information processing method further comprises connecting the one or more personal AI agents to the cyber-vehicle room after the user corresponding to the personal AI agent enters the vehicle interior.

7. The information processing method according to claim 1, wherein
the room is a vehicle interior of a vehicle,
the virtual space is a cyber-vehicle room, and
the information processing method further comprises releasing connection of the one or more personal AI agents to the cyber-vehicle room when the user corresponding to the personal AI agent leaves the vehicle interior or when the vehicle arrives at the destination.

8. The information processing method according to claim 1, wherein
the one or more personal AI agents include a first agent corresponding to a first user in the room and a second agent corresponding to a second user in the room,
the virtual space includes
a first cyber-vehicle room being a cyber-vehicle room enabling each of the AI agents to perform interaction with each other,
a first cyber-private room being a cyber-vehicle room enabling the room AI agent and the first agent to perform interaction between two parties, and
a second cyber-private room being a cyber-vehicle room enabling the room AI agent and the second agent to perform interaction between two parties, and
the information processing method further comprises, by the room AI agent,
performing interaction with a personal AI agent corresponding to at least the user in the first cyber-vehicle room in a case where there is a proposal request related to a first topic that is not related to privacy information about the user from the first user or the second user, and
performing interaction with a personal AI agent corresponding to the user in the first cyber-private room or the second cyber-private room in which information is exchanged between two parties with the personal AI agent corresponding to the user in a case where there is a proposal request related to a second topic related to privacy information about the user from the first user or the second user.

9. The information processing method according to claim 8, wherein
the system incidental to the room includes hardware serving to present information in the room, and
the information processing method further comprises, by the computer, causing the hardware of the system incidental to the room to present an image indicating that an avatar representing a character of an AI agent capable of interacting in the cyber-vehicle room is present and another character is away from a seat, with respect to the cyber-vehicle room in which the room AI agent is interacting out of the first cyber-vehicle room, the first cyber-private room, and the second cyber-private room.

10. The information processing method according to claim 6, wherein
each of the one or more personal AI agents is executed by an information terminal brought into the vehicle interior, and
the information processing method further comprises,
causing, by the computer, a display installed in the vehicle interior to present a code for connecting to the virtual space associated with the vehicle, and
connecting, by each of the one or more personal AI agents, to the virtual space by reading the code by the information terminal.

11. The information processing method according to claim 10, wherein each of the one or more personal AI agents is one selected from available AI agents by an operation performed on the information terminal.

12. The information processing method according to claim 10, wherein
the virtual space is provided by a Social Networking Service (SNS) administering a group in which the one or more personal AI agents participate, and
the information processing method further comprises
causing by the computer, a display installed in the vehicle interior to present a code by which the room AI agent requests participation in the group of the SNS,
reading, by the information terminal, the code requesting the participation, and
permitting, by the personal AI agent of the information terminal, the room AI agent to participate in the group of the SNS in which the room AI agent participates based on the read code.

13. The information processing method according to claim 12, further comprising setting in advance a releasing condition for removing the room AI agent from a group when enrolling the group in the SNS, wherein
the vehicle is a rental car for which a rental period is fixed, and
the releasing condition includes expiration of the rental period of the rental car.

14. A computer comprising:
a processor; and
a memory storing a program for causing the processor to execute the information processing method according to claim 1, wherein
the computer is installed in the room or is connected via a network.

15. A non-transitory computer readable medium on which a computer program executable by a computer is recorded, the computer program causing the computer to execute the information processing method according to claim 1.
